(19) United States
(12) Patent Application Publication
(10) Pub. No.: US 2012/0301699 A1
(43) Pub. Date: Nov. 29, 2012

(54) POLYCARBONATE RESIN AND PRODUCTION PROCESS THEREOF

(75) Inventors: Masami Kinoshita, Chiyoda-ku (JP); Mizuho Saito, Chiyoda-ku (JP); Fumitaka Kondo, Chiyoda-ku (JP)

(73) Assignee: TEIJIN LIMITED, Osaka-shi, Osaka (JP)

(21) Appl. No.: 13/576,863

(22) PCT Filed: Feb. 5, 2010
(86) PCT No.: PCT/JP2010/052111

§ 371 Date: Aug. 2, 2012

(51) Int. Cl. C08G 64/04; C08G 64/30

(52) U.S. Cl. 428/220; 528/201

(57) ABSTRACT

A polycarbonate resin which has a high biogenic matter content, excellent moisture absorption resistance, heat resistance, heat stability and moldability, and high surface energy, as well as a production process thereof.

The polycarbonate resin contains 30 to 100 mol % of a unit represented by the following formula (1) in all the main chains and has (i) a biogenic matter content measured in accordance with ASTM D6866 05 of 25 to 100%, (ii) a specific viscosity at 20° C. of a solution prepared by dissolving 0.7 g of the resin in 100 ml of methylene chloride of 0.2 to 0.6 and (iii) an OH value of 2.5×10³ or less.

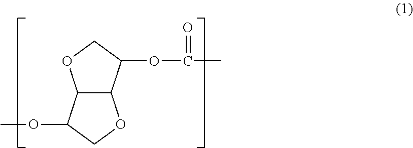

### TECHNICAL FIELD

The present invention relates to a polycarbonate resin. More specifically, it relates to a polycarbonate resin containing a recurring unit derived from sugar which is biogenic matter and having excellent moisture absorption resistance, heat resistance, heat stability and moldability.

### BACKGROUND ART

Polycarbonate resins are polymers in which aromatic or aliphatic dioxy compounds are connected to each other by a carbonate ester. Out of these, a polycarbonate resin (may be referred to as “PC-A” hereinafter) obtained from 2,2-bis(4-hydroxyphenyl)propane (commonly known as “bisphenol A”) is used in many fields because it has excellent transparency, heat resistance and impact resistance.

Polycarbonate resins are generally produced by using raw materials obtained from oil resources. Because of the concern about the depletion of oil resources, it is desired to produce a polycarbonate resin by using raw materials obtained from biogenic matter such as plants. A polycarbonate resin obtained from an ether diol which can be produced from sugar is now under study.

For example, an ether diol represented by the following formula (5) is easily produced from biogenic matter such as sugar or starch.

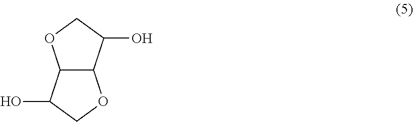

It is known that this ether diol has three stereoisomers. In concrete terms, they are 1,4:3,6-dianhydro-D-sorbitol (to be referred to as “isosorbide” hereinafter) represented by the following formula (9), 1,4:3,6-dianhydro-D-mannitol (to be referred to as “isomannide” hereinafter) represented by the following formula (10), and 1,4:3,6-dianhydro-L-iditol (to be referred to as “isoidide” hereinafter) represented by the following formula (11).

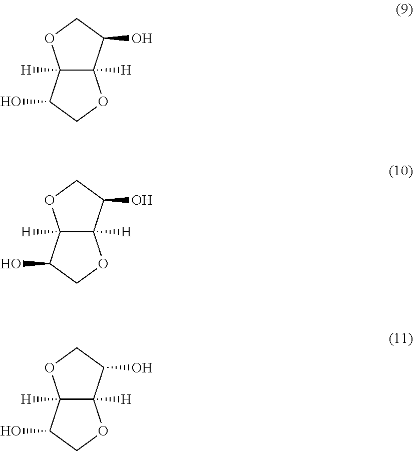

Isosorbide, isomannide and isoidide are obtained from D-glucose, D-mannose and L-idose, respectively. For example, isosorbide can be obtained by hydrogenating D-glucose and then dehydrating it by using an acid catalyst.

The incorporation of especially isosorbide out of the ether diols represented by the formula (5) into a polycarbonate resin has been studied (Patent Documents 1 to 5).

However, an isosorbide-containing polycarbonate resin contains a large number of oxygen atoms and has higher polarity than a polycarbonate resin obtained from a diol having no ether moiety, such as PC-A. Therefore, the isosorbide-containing polycarbonate resin has higher hygroscopic nature than PC-A, whereby it readily causes the deterioration of the dimensional stability of a molded article by moisture absorption and the degradation of heat resistance at the time of wet heating. Further, as the isosorbide-containing polycarbonate resin has low surface energy, a molded article is easily stained and susceptible to abrasion. This surface energy can be evaluated by contact angle with water.

The isosorbide-containing polycarbonate resin has room for the further improvement of moisture absorption resistance, heat resistance, heat stability and moldability as described above. The isosorbide-containing polycarbonate resin also has room for the improvement of a defect caused by low surface energy.
(Patent Document 1) JP-A 56-055425
(Patent Document 2) JP-A 56-110723
(Patent Document 3) JP-A 2003-292603
(Patent Document 4) WO2004/111106
(Patent Document 5) JP-A 2006-232897

### DISCLOSURE OF THE INVENTION

It is therefore an object of the present invention to provide a polycarbonate resin which has a high content of biogenic matter, excellent moisture absorption resistance, heat resistance, heat stability and moldability, and high surface energy. It is still another object of the present invention to provide a molded article such as film which has a low photoelastic constant, high phase difference developability and phase difference controllability, and excellent view angle characteristics as well as high heat resistance and heat stability.

The inventors of the present invention found that, in a polycarbonate resin containing a recurring unit represented by the following formula (1) in the main chain, the amount of a polymer terminal hydroxyl group (OH value) greatly contributes to the water absorption coefficient of a polymer and that a polycarbonate resin having excellent moisture absorption resistance, heat resistance, heat stability and moldability, and high surface energy is obtained by setting the OH value in particular to 2.5×10³ or less. The present invention was accomplished based on this finding.

That is, the present invention is a polycarbonate resin which contains 30 to 100 mol % of a unit represented by the following formula (1) in all the main chains and has (i) a biogenic matter content measured in accordance with ASTM D6866 05 of 25 to 100%, (ii) a specific viscosity at 20° C. of a solution prepared by dissolving 0.7 g of the resin in 100 ml of methylene chloride of 0.2 to 0.6 and (iii) an OH value of 2.5×10³ or less.

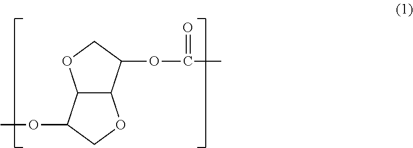

Further, the present invention is a process for producing a polycarbonate resin by reacting (A) an ether diol (component A) represented by the following formula (5), (B) a dial and/or a diphenol (component B) except for the component A, (C) a diester carbonate (component C), and (D) 0.01 to 7 mol % based on the total of the component A and the component B of a hydroxy compound (component D) represented by the following formula (6) or (7).

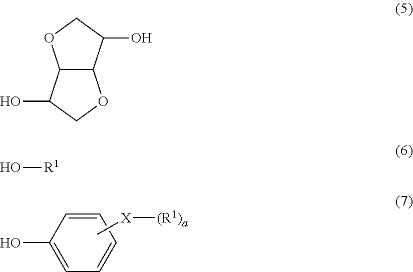

{In the above formulas (6) and (7), R¹ is an alkyl group having 4 to 30 carbon atoms, aralkyl group having 7 to 30 carbon atoms, perfluoroalkyl group having 4 to 30 carbon atoms, phenyl group or group represented by the following formula (4), X is at least one bond selected from the group consisting of a single bond, ether bond, thioether bond, ester bond, amino bond and amide bond, and a is an integer of 1 to 5.}

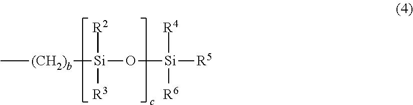

(In the above formula (4), R², R³, R⁴, R⁵ and R⁶ are each independently at least one group selected from the group consisting of an alkyl group having 1 to 10 carbon atoms, cycloalkyl group having 6 to 20 carbon atoms, alkenyl group having 2 to 10 carbon atoms, aryl group having 6 to 10 carbon atoms and aralkyl group having 7 to 20 carbon atoms, b is an integer of 0 to 3, and c is an integer of 4 to 100.)

Further, the present invention is a process for producing a polycarbonate resin by reacting (A) an ether diol (component A) represented by the following formula (5), (B) a diol and/or a diphenol (component B) except for the component A, and (E) phosgene (component E) in an inactive solvent in the presence of an acid binder, wherein

(D) a hydroxy compound (component D) represented by the following formula (6) or (7) is reacted as an end-sealing agent.

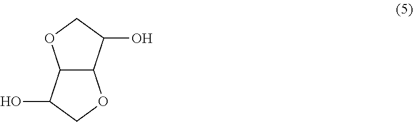

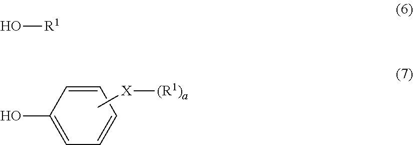

(In the above formulas (6) and (7), R¹ is an alkyl group having 4 to 30 carbon atoms, aralkyl group having 7 to 30 carbon atoms, perfluoroalkyl group having 4 to 30 carbon atoms, phenyl group or group represented by the following formula (4), X is at least one bond selected from the group consisting of a single bond, ether bond, thioether bond, ester bond, amino bond and amide bond, and a is an integer of 1 to 5.)

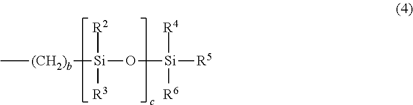

(In the above formula (4), R², R³, R⁴, R⁵ and R⁶ are each independently at least one group selected from the group consisting of an alkyl group having 1 to 10 carbon atoms, cycloalkyl group having 6 to 20 carbon atoms, alkenyl group having 2 to 10 carbon atoms, aryl group having 6 to 10 carbon atoms and aralkyl group having 7 to 20 carbon atoms, b is an integer of 0 to 3, and c is an integer of 4 to 100.)

Further, the present invention is a process for producing a polycarbonate resin by reacting a dihydroxy component consisting of 30 to 100 mol % of an ether diol (component A) represented by the following formula (5)

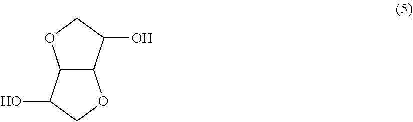

and 0 to 70 mol % of a diol or a diphenol (component B) except for the ether diol (component A) with a diester carbonate component (component C) by heating at normal pressure and then melt polycondensing the reaction product under reduced pressure by heating at 180 to 280° C. in the presence of a polymerization catalyst, wherein
(i) the weight ratio of the component C to the dihydroxy component (component C/(component A+component B)) is set to 1.05 to 0.97 at the start of polymerization; and
(ii) the component C is further added to ensure that the weight ratio of the component C to the dihydroxy component (component C/(component A+component B)) during polymerization becomes 1.08 to 1.00.

The present invention includes a molded article formed of the above polycarbonate resin.

### BEST MODE FOR CARRYING OUT THE INVENTION

The present invention will be described in detail hereinunder.

### <Polycarbonate Resin>

### (Main Chain)

The polycarbonate resin of the present invention contains a unit represented by the following formula (1) in the main chain. The content of the unit represented by the following formula (1) in the main chain is 30 to 100 mol %, preferably 50 to 95 mol %, more preferably 55 to 90 mol %.

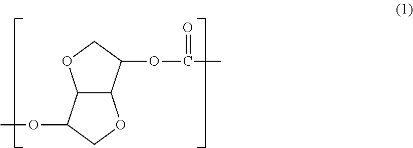

The unit represented by the formula (1) is preferably a unit derived from isosorbide, isomannide or isoidide. It is particularly preferably a unit derived from isosorbide (1,4:3,6-dianhydro-D-sorbitol).

The polycarbonate resin of the present invention contains 0 to 70 mol %, preferably 5 to 50 mol %, more preferably 10 to 45 mol % of a unit represented by the following formula (12) derived from a diphenol or a unit represented by the following formula (16) derived from a diol besides the unit represented by the above formula (1) in the main chain. (formula (12))

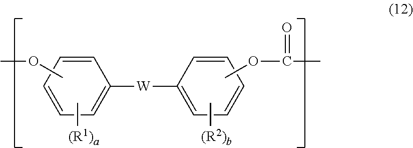

In the formula (12), R¹ and R² are each independently at least one group selected from the group consisting of a hydrogen atom, halogen atom, alkyl group having 1 to 10 carbon atoms, alkoxy group having 1 to 10 carbon atoms, cycloalkyl group having 6 to 20 carbon atoms, cycloalkoxy group having 6 to 20 carbon atoms, alkenyl group having 2 to 10 carbon atoms, aryl group having 6 to 10 carbon atoms, aryloxy group having 6 to 10 carbon atoms, aralkyl group having 7 to 20 carbon atoms, aralkyloxy group having 7 to 20 carbon atoms, nitro group, aldehyde group, cyano group and carboxyl group, and when there are R¹'s and R²'s, they may be the same or different.

R¹ and R² are preferably each independently at least one group selected from the group consisting of a hydrogen atom, halogen atom, alkyl group having 1 to 10 carbon atoms, alkoxy group having 1 to 10 carbon atoms, cycloalkyl group having 6 to 20 carbon atoms, cycloalkoxy group having 6 to 20 carbon atoms, aryl group having 6 to 10 carbon atoms, aryloxy group having 6 to 10 carbon atoms, aralkyl group having 7 to 20 carbon atoms and aralkyloxy group having 7 to 20 carbon atoms, and when there are R¹'s and R²'s, they may be the same or different.

a and b are each independently an integer of 1 to 4.

W is at least one bonding group selected from the group consisting of a single bond and bonding groups represented by the following formulas (13).

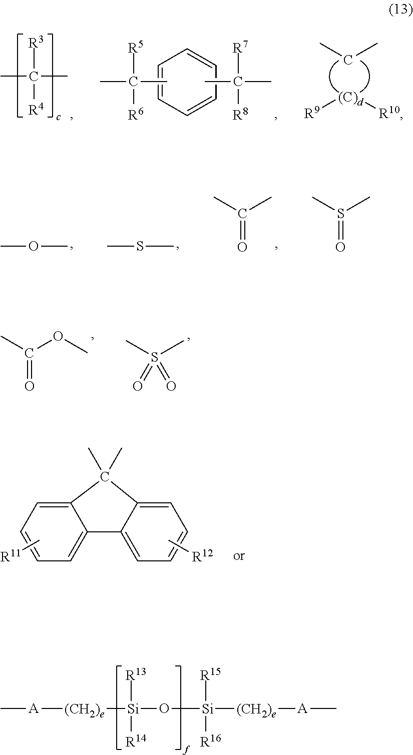

In the above formulas (13), R³, R⁴, R⁵, R⁶, R⁷, R⁸, R⁹ and R¹⁰ are each independently at least one group selected from the group consisting of a hydrogen atom, alkyl group having 1 to 10 carbon atoms, aryl group having 6 to 10 carbon atoms and aralkyl group having 7 to 20 carbon atoms. When there are R³'s, R⁴'s, R⁵'s, R⁶'s, R⁷'s, R⁸'s, R⁹'s and R¹⁰'s, they may the same or different.

R¹¹ and R¹² are each independently at least one group selected from the group consisting of a hydrogen atom, halogen atom, alkyl group having 1 to 10 carbon atoms, alkoxy group having 1 to 10 carbon atoms, cycloalkyl group having 6 to 20 carbon atoms, cycloalkoxy group having 6 to 20 carbon atoms, alkenyl group having 2 to 10 carbon atoms, aryl group having 6 to 10 carbon atoms, aryloxy group having 6 to 10 carbon atoms, aralkyl group having 7 to 20 carbon atoms, aralkyloxy group having 7 to 20 carbon atoms, nitro group, aldehyde group, cyano group and carboxyl group.

R¹³, R¹⁴, R¹⁵ and R¹⁶ are each independently at least one group selected from the group consisting of an alkyl group having 1 to 10 carbon atoms, cycloalkyl group having 6 to 20 carbon atoms, alkenyl group having 2 to 10 carbon atoms, aryl group having 6 to 10 carbon atoms and aralkyl group having 7 to 20 carbon atoms. When there are R¹³'s, R¹⁴'s, R¹⁵'s and R¹⁶'s, they may be the same or different.

c is an integer of 1 to 10, d is an integer of 4 to 7, e is an integer of 1 to 3, and f is an integer of 1 to 100.

W is particularly preferably at least one bonding group selected from the group consisting of a single bond and bonding groups represented by the following formulas (14).

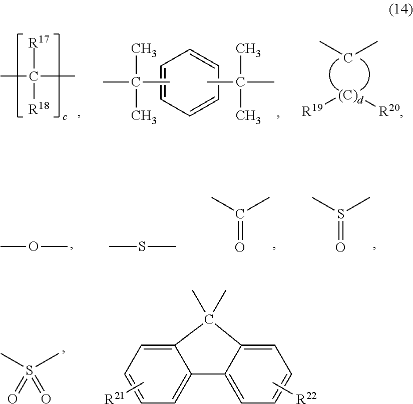

In the above formulas (14), R¹⁷ and R¹⁸ are each independently a hydrogen atom or hydrocarbon group having 1 to 10 carbon atoms. When there are R¹⁷'s and R¹⁸'s, they may be the same or different.

R¹⁹ and R²⁰ are each independently a hydrogen atom or alkyl group having 1 to 3 carbon atoms. When there are R¹⁹'s and R²⁰'s, they may be the same or different.

R²¹ and R²² are each independently a hydrogen atom or alkyl group having 1 to 3 carbon atoms. When there are R²¹'s and R²²'s, they may be the same or different. c is an integer of 1 to 10, and d is an integer of 4 to 7.

W is particularly preferably at least one bonding group selected from the group consisting of bonding groups represented by the following formulas (15).

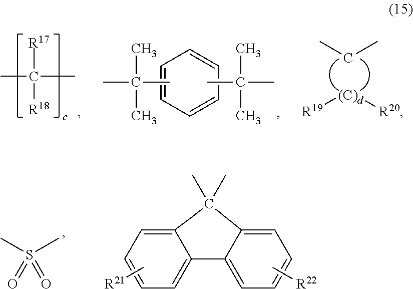

In the above formulas (15), R¹⁷, R¹⁸, R¹⁹, R²⁰, R²¹, R²², c and d are as defined in the above formulas (14).

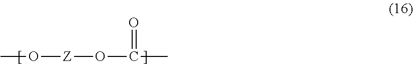

In the formula (16), Z is a divalent aliphatic group having 2 to 20 carbon atoms, preferably an aliphatic group having 3 to 15 carbon atoms. The aliphatic group is preferably an alkanediyl group having 2 to 20 carbon atoms, more preferably an alkanediyl group having 3 to 15 carbon atoms. Specific examples thereof include linear alkanediyl groups such as 1,3-propanediyl group, 1,4-butanediyl group, 1,5-pentanediyl group and 1,6-hexanediyl group. Alicyclic alkanediyl groups such as cyclohexanediyl group and dimethyl cyclohexanediyl group may also be used. Out of these, 1,3-propanediyl group, 1,4-butanediyl group, hexanediyl group, spiroglycolyl group and dimethyl cyclohexanediyl group are preferred. These aliphatic groups may be used alone or in combination of two or more.

### (Biogenic Matter Content)

The polycarbonate resin of the present invention has a biogenic matter content measured in accordance with ASTM D6866 05 of 25 to 100%, preferably 40 to 100%, more preferably 50 to 100%.

### (Specific Viscosity)

The specific viscosity at 20° C. of a solution prepared by dissolving 0.7 g of the polycarbonate resin of the present invention in 100 ml of methylene chloride is 0.2 to 0.6, preferably 0.2 to 0.45, more preferably 0.22 to 0.4. When the specific viscosity is lower than 0.2, it is difficult to provide sufficiently high mechanical strength to the obtained molded article. When the specific viscosity is higher than 0.6, the ratio of the terminal group inevitably lowers, thereby making it impossible to obtain a satisfactory terminal modification effect, and melt flowability becomes too high, whereby the melting temperature required for molding becomes higher than the decomposition temperature disadvantageously.

### (OH Value)

The polycarbonate resin of the present invention has an OH value of 2.5×10³ or less, preferably 2.0×10³ or less, more preferably 1.5×10³ or less. When the OH value is larger than 2.5×10³, the water absorbability of the polycarbonate resin increases and the heat stability thereof degrades disadvantageously. The OH value is calculated from a terminal ratio obtained by NMR measurement.

### (Water Absorption Coefficient)

The water absorption coefficient at 23° C. after 24 hours of the polycarbonate resin of the present invention is preferably 0.75% or less, more preferably 0.7% or less. When the water absorption coefficient falls within the above range, the polycarbonate resin is preferred from the viewpoints of wet heat resistance and a low dimensional change rate.

### (Saturation Water Absorption Coefficient)

The polycarbonate resin of the present invention has a saturation water absorption coefficient in 23° C. water of preferably 0 to 5%, more preferably 0 to 4.8%, much more preferably 0 to 4.5%. When the water absorption coefficient falls within the above range, the polycarbonate resin is preferred from the viewpoints of wet heat resistance and a low dimensional change rate.

(Contact Angle with Water)

The contact angle with water of the polycarbonate resin of the present invention is preferably 70 to 180′, more preferably 72 to 180′. When the contact angle with water falls within the above range, the polycarbonate resin is preferred from the viewpoints of antifouling property, abrasion resistance and releasability.

### (Molecular Weight Retention)

The molecular weight retention at 120° C. and 100% RH after 11 hours of the polycarbonate resin of the present invention is preferably 80% or more, more preferably 85% or more.

### (Glass Transition Temperature: Tg)

The glass transition temperature (Tg) of the polycarbonate resin of the present invention is preferably 100° C. or higher, more preferably 100 to 170° C., much more preferably 110 to 160° C. When Tg is lower than 100° C., the polycarbonate resin deteriorates in heat resistance and when Tg is higher than 170° C., the polycarbonate resin deteriorates in melt flowability at the time of molding.

### (Terminal Group)

The polycarbonate resin of the present invention preferably contains a terminal group represented by the following formula (2) or (3).

—O—R¹ (2)

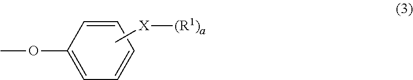

In the formulas (2) and (3), R¹ is an alkyl group having 4 to 30 carbon atoms, aralkyl group having 7 to 30 carbon atoms, perfluoroalkyl group having 4 to 30 carbon atoms, phenyl group or group represented by the following formula (4).

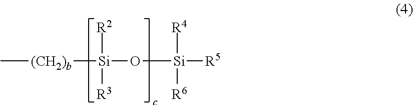

The number of carbon atoms of the alkyl group represented by R¹ is preferably 4 to 22, more preferably 8 to 22. Examples of the alkyl group include hexyl group, octyl group, nonyl group, decyl group, undecyl group, dodecyl group, pentadecyl group, hexadecyl group and octadecyl group.

The number of carbon atoms of the aralkyl group represented by R¹ is preferably 8 to 20, more preferably 10 to 20. Examples of the aralkyl group include benzyl group, phenethyl group, methylbenzyl group, 2-phenylpropan-2-yl group and diphenylmethyl group.

The number of carbon atoms of the perfluoroalkyl group represented by R¹ is preferably 2 to 20. Examples of the perfluoroalkyl group include 4,4,5,5,6,6,7,7,7-nonafluoroheptyl group, 4,4,5,5,6,6,7,7,8,8,9,9,9-tridecafluorononyl group and 4,4,5,5,6,6,7,7,8,8,9,9,10,10,11,11,11-heptadecafluoround ecyl group.

In the formula (4), R², R³, R⁴, R⁵ and R⁶ are each independently at least one group selected from the group consisting of an alkyl group having 1 to 10 carbon atoms, cycloalkyl group having 6 to 20 carbon atoms, alkenyl group having 2 to 10 carbon atoms, aryl group having 6 to 10 carbon atoms and aralkyl group having 7 to 20 carbon atoms.

Examples of the alkyl group having 1 to 10 carbon atoms in the formula (4) include methyl group, ethyl group, propyl group, butyl group and heptyl group. Examples of the cycloalkyl group having 6 to 20 carbon atoms include cyclohexyl group, cyclooctyl group, cyclononyl group and cyclodecyl group. Examples of the alkenyl group having 2 to 10 carbon atoms include ethenyl group, propenyl group, butenyl group and heptenyl group. Examples of the aryl group having 6 to 10 carbon atoms include phenyl group, tolyl group, dimethylphenyl group and naphthyl group. Examples of the aralkyl group having 7 to 20 carbon atoms include benzyl group, phenethyl group, methylbenzyl group, 2-phenylpropan-2-yl group and diphenylmethyl group.

In the formula (4), preferably, R², R³, R⁴, R⁵ and R⁶ are each independently at least one group selected from the group consisting of an alkyl group having 1 to 10 carbon atoms and aryl group having 6 to 10 carbon atoms. Particularly preferably, they are each independently at least one group selected from the group consisting of methyl group and phenyl group.

b is an integer of 0 to 3, preferably 1 to 3, more preferably 2 to 3. c is an integer of preferably 4 to 100, more preferably 4 to 50, much more preferably 8 to 50.

X in the formula (3) is at least one bond selected from the group consisting of a single bond, ether bond, thioether bond, ester bond, amino bond and amide bond. X is preferably at least one bond selected from the group consisting of a single bond, ether bond and ester bond. X is particularly preferably a single bond or an ester bond.

a is an integer of preferably 1 to 5, more preferably 1 to 3, much more preferably 1.

The terminal group represented by the above formula (2) or (3) is preferably derived from biogenic matter. Examples of the biogenic matter include long-chain alkyl alcohols having 14 or more carbon atoms such as cetanol, stearyl alcohol and behenyl alcohol.

The content of the terminal group represented by the formula (2) or (3) is preferably 0.01 to 7 mol %, more preferably 0.05 to 7 mol %, much more preferably 0.1 to 6.8 mol % based on the polymer main chain. When the content of the terminal group represented by the formula (2) or (3) falls within the above range, effects (moldability, high contact angle and moisture absorption resistance) caused by terminal modification are advantageously obtained.

### <Production Process (I) of Polycarbonate Resin>

The polycarbonate resin of the present invention can be produced by reacting (A) an ether diol (component A) represented by the following formula (5), (B) a diol and/or a diphenol (component B) except for the component A, (C) a diester carbonate (component C) and (D) 0.01 to 7 mol % based on the total of the component A and the component B of a hydroxy compound (component D) represented by the following formula (6) or (7) (production process (I)).

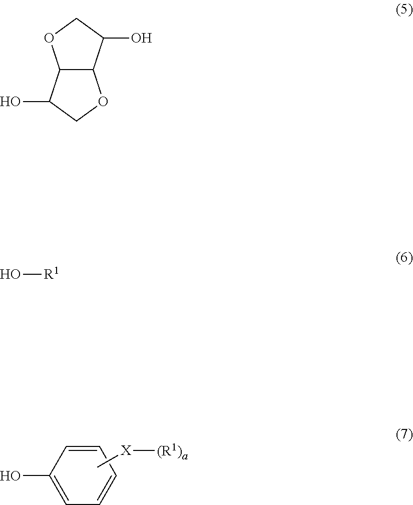

In the formulas (6) and (7), R¹, X and a are as defined in the formulas (2) and (3).

### (Ether Diol: Component A)

The ether diol (component A) is preferably one of isosorbide, isomannide and isoidide. These ether diols derived from sugar are also obtained from biomass in the natural world and so-called “renewable resources”. Isosorbide can be produced by hydrogenating D-glucose obtained from starch and then dehydrating it. The other ether diols are obtained through a similar reaction except for the starting material. The component A is particularly preferably isosorbide (1,4:3,6-dianhydro-D-sorbitol). Isosorbide is an ether diol which can be easily produced from starch, can be acquired abundantly as a resource and is superior to isommanide and isoidide in production ease, properties and application range.

The amount of the component A is preferably 30 to 100 mol %, more preferably 50 to 95 mol %, much more preferably 55 to 90 mol % based on the total of the component A and the component B.

### (Diol, Diphenol: Component B)

The polycarbonate resin of the present invention is produced by using a diol and/or a diphenol (component B) except for the component A besides the ether diol (component A) represented by the above formula (5)). The amount of the component B is preferably 0 to 70 mol %, more preferably 5 to 50 mol %, much more preferably 10 to 45 mol % based on the total of the component A and the component B.

### (Diol)

The diol except for the ether diol (component A) is preferably a diol represented by the following formula (18).

HO—Z—OH (18)

In the above formula (18), Z is as defined in the above formula (16).

The diol is preferably an aliphatic diol having 2 to 20 carbon atoms, more preferably an aliphatic diol having 3 to 15 carbon atoms. Specific examples thereof include linear diols such as 1,3-propanediol, 1,4-butanediol, 1,5-pentanediol and 1,6-hexanediol, and alicyclic alkylenes such as cyclohexanediol and cyclohexanedimethanol. Out of these, 1,3-propanediol, 1,4-butanediol, hexanediol, spiroglycol and cyclohexanedimethanol are preferred. These diols may be used alone or in combination of two or more.

### (Diphenol)

The diphenol is preferably a bisphenol represented by the following formula (17).

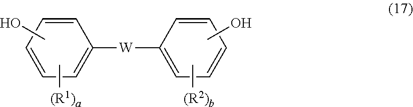

In the formula (17), W, R¹, R², a and b are as defined in the above formula (12).

Examples of the bisphenol include 4,4′-biphenol, 3,3′,5,5′-tetrafluoro-4,4′-biphenol, α,α′-bis(4-hydroxyphenyl)-o-diisopropylbenzene, α,α′-bis(4-hydroxyphenyl)-m-diisopropylbenzene (commonly known as “bisphenol M”), 2,2-bis(4-hydroxyphenyl)-4-methylpentane, α,α′-bis(4-hydroxyphenyl)-p-diisopropylbenzene, α,α′-bis(4-hydroxyphenyl)-m-bis(1,1,1,3,3,3-hexafluoroisopropyl)benzene, 9,9-bis(4-hydroxyphenyl) fluorene, 9,9-bis(4-hydroxy-3-methylphenyl)fluorene, 9,9-bis(3-fluoro-4-hydroxyphenyl)fluorene, 9,9-bis(4-hydroxy-3-trifluoromethylphenyl)fluorene, 1,1-bis(4-hydroxyphenyl)cyclohexane, 1,1-bis(4-hydroxyphenyl)-3,3,5-trimethylcyclohexane, 1,1-bis(4-hydroxyphenyl)-4-isopropylcyclohexane, 1,1-bis(3-cyclohexyl-4-hydroxyphenyl)cyclohexane, 1,1-bis(4-hydroxyphenyl)cyclopentane, 1,1-bis(3-fluoro-4-hydroxyphenyl)cyclohexane, 1,1-bis(4-hydroxyphenyl)perfluorocyclohexane, 4,4′-dihydroxydiphenyl ether, 4,4′-dihydroxy-3,3′-dimethyldiphenyl ether, 4,4′-dihydroxydiphenyl sulfone, 4,4′-dihydroxydiphenyl sulfoxide, 4,4′-dihydroxydiphenyl sulfide, 3,3′-dimethyl-4,4′-dihydroxydiphenyl sulfide, 3,3′-dimethyl-4,4′-dihydroxydiphenyl sulfone, 4,4′-dihydroxydiphenyl sulfone, 4,4′-dihydroxy-3,3′-diphenyl sulfide, 4,4′-dihydroxy-3,3′-diphenyl sulfoxide, 4,4′-dihydroxy-3,3′-diphenyl sulfone, 1,1-bis(4-hydroxyphenyl)methane, 1,1-bis(4-hydroxyphenyl)ethane, 2,2-bis(4-hydroxyphenyl)propane (commonly known as “bisphenol A”), 1,1-bis(4-hydroxyphenyl)-1-phenylethane, 2,2-bis(4-hydroxy-3-methylphenyl)propane (commonly known as “bisphenol C”), 2,2-bis(4-hydroxyphenyl)butane, 2,2-bis(4-hydroxyphenyl)pentane, 2,2-bis(4-hydroxy-3-phenylphenyl)propane, 2,2-bis(3-isopropyl-4-hydroxyphenyl)propane, 2,2-bis(3-tert-butyl-4-hydroxyphenyl)propane, 2,2-bis(4-hydroxyphenyl)butane, 4,4-bis(4-hydroxyphenyl)heptane, 2,2-bis(4-hydroxyphenyl)octane, 1,1-bis(4-hydroxyphenyl)decane, 1,1-bis(3-methyl-4-hydroxyphenyl)decane, 1,1-bis(2,3-dimethyl-4-hydroxyphenyl)decane, 2,2-bis(3-bromo-4-hydroxyphenyl)propane, bis(4-hydroxyphenyl)diphenylmethane, 1,1-bis(4-hydroxyphenyl)-4-isopropylcyclohexane, 2,2-bis(4-hydroxyphenyl)-1,1,1,3,3,3-hexafluoropropane (commonly known as “bisphenol AF”), 2,2-bis(4-hydroxy-3-methylphenyl)-1,1,1,3,3,3-hexafluoro propane, 2,2-bis(3,5-dimethyl-4-hydroxyphenyl)-1,1,1,3,3, hexafluoropropane, 2,2-bis(3-fluoro-4-hydroxyphenyl)-1,1,1,3,3,3-hexafluoro propane, 2,2-bis(3,5-difluoro-4-hydroxyphenyl)-1,1,1,3,3,3-hexafluoropropane, 2,2-bis(3,5-dibromo-4-hydroyphenyl)propane, 2,2-bis(3,5-dichloro-4-hydroxyphenyl)propane, 2,2-bis(3,5-dimethyl-4-hydroxyphenyl)propane and 2,2-bis(3-cyclohexyl-4-hydroxyphenyl)propane.

Out of these, bisphenol M, 9,9-bis(4-hydroxy-3-methylphenyl)fluorene, 1,1-bis(4-hydroxyphenyl)cyclohexane, 1,1-bis(4-hydroxyphenyl)-3,3,5-trimethylcyclohexane, 2,2-bis(4-hydroxyphenyl)-4-methylpentane, 3,3′-dimethyl-4,4′-dihydroxydiphenyl sulfide, bisphenol A, bisphenol C, bisphenol AF and 1,1-bis(4-hydroxyphenyl)decane are preferred. These bisphenols may be used alone or in combination of two or more.

### (Diester Carbonate: Component C)

The polycarbonate resin of the present invention is produced by using a diester carbonate (component C) to form a carbonate bond.

The diester carbonate (component C) is, for example, a diester carbonate having an aryl group or aralkyl group having 6 to 12 carbon atoms, or an alkyl group having 1 to 4 carbon atoms, all which may be substituted. Specific examples thereof include diphenyl carbonate, bis(chlorophenyl)carbonate, m-cresyl carbonate, dinaphthyl carbonate, bis(diphenyl)carbonate, dimethyl carbonate, diethyl carbonate and dibutyl carbonate. Out of these, diphenyl carbonate is particularly preferred.

As for the amount of the diester carbonate (component C), the (component C/(component A+component B)) molar ratio of the diester carbonate (component C) to the total of the ether diol (component A) and the diol and the diphenol (component B) except for the component A is preferably 1.05 to 0.97, more preferably 1.03 to 0.97, much more preferably 1.03 to 0.99. When the amount of the component C is larger than 1.05 mols, a sufficiently high degree of polymerization is not obtained. When the amount of the component C is smaller than 0.97 mol, not only polymerization does not proceed but also an untreated ether diol or an unreacted hydroxy compound remains.

### (Hydroxy Compound: Component D)

The polycarbonate resin of the present invention is produced by using a hydroxy compound (component D) represented by the following formula (6) or (7) besides the components A to C.

In the hydroxy compound (component D) represented by the formula (6) or (7), R¹, X, a, R², R³, R⁴, R⁵, R⁶, b and c are as defined in the formulas (2) and (3). The hydroxy compounds (component D) may be used alone or in combination of two or more. When two or more hydroxy compounds are used, the hydroxy compound (component D) represented by the formula (6) or (7) and another hydroxy compound except for the above hydroxy compound may be used in combination. The hydroxy compound (component D) improves the heat resistance, heat stability, moldability and water absorption resistance of the polycarbonate.

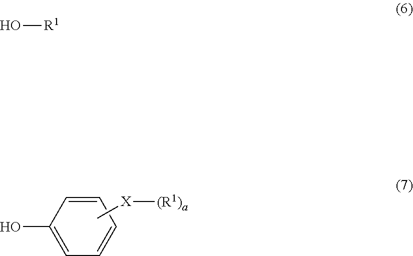

Since the polycarbonate resin of the present invention has a recurring unit derived from a raw material obtained from a renewable resource such as a plant in the main chain structure, preferably, the hydroxy compound (component D) constituting the terminal structure is also derived from biogenic matter such as a plant. Hydroxy compounds obtained from plants include long-chain alkyl alcohols having 14 or more carbon atoms obtained from vegetable oils (such as cetanol, stearyl alcohol and behenyl alcohol).

The amount of the hydroxy compound (component D) is preferably 0.01 to 7 mol %, more preferably 0.05 to 7 mol %, much more preferably 0.1 to 6.8 mol % based on the total amount of the ether diol (component A) and the diol and diphenol (component B) except for the ether diol. When the amount of the hydroxy compound is smaller than 0.01 mol %, the terminal modification effect is not obtained. When the amount of the hydroxy compound is larger than 7 mol %, the amount of an end-sealing agent is too large, thereby making it impossible to obtain a polycarbonate resin having a polymerization degree high enough for molding. The time when the hydroxy compound (component D) is added may be the initial stage or the latter stage of a reaction.

The reaction may be carried out by melt polymerization. The melt polymerization may be carried out by distilling off an alcohol or a phenol formed by the transesterification reaction of the components A to D at a high temperature under reduced pressure.

### (Reaction Temperature)

The reaction temperature is preferably as low as possible in order to suppress the decomposition of the ether diol and obtain a resin which is rarely colored and has high viscosity. However, to make the polymerization reaction proceed properly, the polymerization temperature is preferably 180 to 280° C., more preferably 180 to 270° C.

Preferably, after the ether diol and the diester carbonate are heated at normal pressure to be pre-reacted with each other in the initial stage of the reaction, the pressure is gradually reduced to about 1.3×10⁻³ to 1.3×10⁻⁵ MPa in the latter stage of the reaction so as to facilitate the distillation-off of the formed alcohol or phenol. The reaction time is generally about 1 to 4 hours.

### (Polymerization Catalyst)

A polymerization catalyst may be used to accelerate the polymerization rate. Examples of the polymerization catalyst include alkali metal compounds such as sodium hydroxide, potassium hydroxide, sodium carbonate, potassium carbonate, sodium hydrogen carbonate, sodium salts of a dihydric phenol and potassium salts of a dihydric phenol. Alkali earth metal compounds such as calcium hydroxide, barium hydroxide and magnesium hydroxide are also included.

Nitrogen-containing basic compounds such as tetramethylammonium hydroxide, tetarethylammonium hydroxide, tetrabutylammonium hydroxide, trimethylamine and triethylamine may also be used.

Alkoxides of an alkali metal or an alkali earth metal, and organic acid salts, zinc compounds, boron compounds, aluminum compounds, silicon compounds, germanium compounds, organic tin compounds, lead compounds, osmium compounds, antimony compounds, manganese compounds, titanium compounds and zirconium compounds of an alkali metal or an alkali earth metal may also be used. They may be used alone or in combination of two or more.

At least one compound selected from the group consisting of a nitrogen-containing basic compound, an alkali metal compound and an alkali earth metal compound is preferably used as the polymerization catalyst. Out of these, a combination of a nitrogen-containing basic compound and an alkali metal compound is particularly preferably used.

The amount of the polymerization catalyst is preferably 1×10⁻⁹ to 1×10⁻³ equivalent, more preferably 1×10⁻⁸ to 5×10⁻⁴ equivalent based on 1 mol of the diester carbonate (component C).

The reaction system is preferably maintained in a gas atmosphere such as nitrogen inactive to raw materials, a reaction mixture and a reaction product. Inert gases except for nitrogen include argon. Additives such as an antioxidant may be further added as required.

### (Catalyst Deactivator)

A catalyst deactivator may be added to the polycarbonate resin of the present invention. Known catalyst deactivators may be used as the catalyst deactivator. Out of these, ammonium salts and phosphonium salts of sulfonic acid are preferred. Ammonium salts and phosphonium salts of dodecylbenzenesulfonic acid such as tetrabutylphosphonium salts of dodecylbenzenesulfonic acid are more preferred. Ammonium salts and phosphonium salts of paratoluenesulfonic acid such as tetrabutylammonium salts of paratoluenesulfonic acid are also preferred. Methyl benzenesulfonate, ethyl benzenesulfonate, butyl benzenesulfonate, octyl benzenesulfonate, phenyl benzenesulfonate, methyl paratoluenesulfonate, ethyl paratoluenesulfonate, butyl paratoluenesulfonate, octyl paratoluenesulfonate and phenyl paratoluenesulfonate are preferably used as the ester of sulfonic acid. Out of these, tetrabutylphosphonium salts of dodecylbenzenesulfonic acid are most preferably used. The amount of the catalyst deactivator is preferably 0.5 to 50 mols, more preferably 0.5 to 10 mols, much more preferably 0.8 to 5 mols based on 1 mol of the polymerization catalyst selected from an alkali metal compound and/or an alkali earth metal compound.

Therefore, it is preferred that an ether diol (component A), a diol and/or a diphenol (component B) except for the ether diol, a diester carbonate (component C) and a hydroxy compound (component D) should be reacted by heating at normal pressure and then melt polycondensed while they are heated at 180 to 280° C. under reduced pressure.

### <Production Process (II) of Polycarbonate Resin>

The polycarbonate resin of the present invention can be produced by reacting an ether diol (component A), a diol and/or a diphenol (component B) except for the component A and phosgene (component E) in an inert solvent in the presence of an acid binder such as pyridine. That is, the polycarbonate resin of the present invention can be produced by reacting (A) an ether diol (component A) represented by the following formula (5), (B) a diol and/or a diphenol (component B) except for the component A, and (E) phosgene (component E) in an inert solvent in the presence of an acid binder, wherein

a hydroxy compound (component D) represented by the following formula (6) or (7) is reacted as an end-sealing agent (production process (II)).

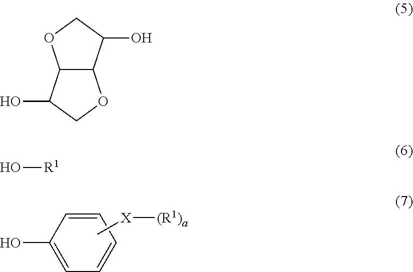

In the formulas (6) and (7), R¹, X, a, R², R³, R⁴, R⁵, R⁶, b and c are as defined in the above formulas (2) and (3).

The components A, B and D are the same as those used in the production process (I). The ether diol (component A) is preferably isosorbide (1,4:3,6-dianhydro-D-sorbitol). The hydroxy compound (component D) is preferably derived from biogenic matter. Heat stability is improved by using the hydroxy compound (component D) represented by the formula (6) or (7) as an end-sealing agent.

### (Acid Binder)

The acid binder is preferably at least one selected from the group consisting of pyridine, quinoline and dimethylaniline. The acid binder is particularly preferably pyridine. The amount of the acid binder is preferably 2 to 100 mols, more preferably 2 to 50 mols based on 1 mol of phosgene (component E).

### (Inert Solvent)

Examples of the inert solvent include hydrocarbons such as benzene, toluene and xylene, and halogenated hydrocarbons such as methylene chloride, chloroform, dichloroethane, chlorobenzene and dichlorobenzene. Out of these, halogenated hydrocarbons such as methylene chloride, chloroform, dichloroethane, chlorobenzene and dichlorobenzene are preferred. Methylene chloride is most preferred. The reaction temperature is preferably 0 to 40° C., more preferably 5 to 30° C. The reaction time is generally a few minutes to a few days, preferably 10 minutes to 5 hours.

### <Production Process (III) of Polycarbonate Resin>

The polycarbonate resin having a low OH value of the present invention can be produced without using an end-sealing agent.

That is, the polycarbonate resin of the present invention can be produced by reacting a dihydroxy component consisting of 30 to 100 mol % of an ether diol (component A) represented by the following formula (5)

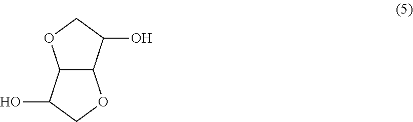

and 0 to 70 mol % of a diol or a diphenol (component B) except for the component A with a diester carbonate component (component C) by heating at normal pressure in the presence of polymerization catalyst and then melt polycondensing the reaction product while heating at 180 to 280° C. under reduced pressure, wherein
(i) the (component C/(component A+component B)) ratio of the component C to the dihydroxy component becomes 1.05 to 0.97 at the start of polymerization; and
(ii) the component C is further added to ensure that the (component C/(component A+component B)) ratio of the component C to the dihydroxy component during polymerization becomes 1.08 to 1.00.

Although the reaction temperature is preferably as low as possible in order to suppress the decomposition of the ether diol (component A) and obtain a resin which is rarely colored and has high viscosity, the polymerization temperature is preferably 180 to 280° C., more preferably 180 to 270° C. in order to make a polymerization reaction proceed properly.

Preferably, the dihydroxy component and the diester carbonate are heated at normal pressure in the initial stage of the reaction to be pre-reacted with each other, and the pressure is gradually reduced to about 1.3×10⁻³ to 1.3×10⁻⁵ MPa in the latter stage of the reaction to facilitate the distillation-off of the formed alcohol or phenol. The reaction time is generally about 0.5 to 4 hours.

The diester carbonate (component C) includes an ester such as an aryl group or aralkyl group having 6 to 20 carbon atoms, or an alkyl group having 1 to 18 carbon atoms, all of which may be substituted. Specific examples of the diester carbonate include diphenyl carbonate, bis(chlorophenyl)carbonate, m-cresyl carbonate, dinaphthyl carbonate, bis (p-butylphenyl)carbonate, dimethyl carbonate, diethyl carbonate and dibutyl carbonate. Out of these, diphenyl carbonate is particularly preferred.

The diester carbonate (component C) is divided into two to be added in the initial stage of the reaction (start of polymerization) and the middle stage of the reaction (during polymerization). At the start of polymerization, the (component C/(component A+component B)) ratio of the diester carbonate to the dihydroxy component is set to 1.05 to 0.97.

During polymerization, the diester carbonate (component C) is further added to ensure that the (component C/(component A+component B)) ratio of the diester carbonate (component C) to the dihydroxy component becomes 1.08 to 1.00.

The weight ratio of the diester carbonate (component C) added at the start of polymerization to the diester carbonate (component C) added during polymerization is preferably 99:1 to 90:10, more preferably 98:2 to 95:5. When the diester carbonate (component C) is not added in the middle stage of the reaction, the OH value exceeds the preferred range with the result that the polycarbonate resin exhibits high water absorbability, thereby causing a dimensional change or the deterioration of heat stability. When the diester carbonate is added at a time at the start of polymerization without being further added during polymerization to ensure that the ratio of the diester carbonate to the dihydroxy component becomes higher than 1.05, molar balance is lost and a sufficiently high degree of polymerization is not obtained disadvantageously.

At least one polymerization catalyst selected from the group consisting of a nitrogen-containing basic compound, an alkali metal compound and an alkali earth metal compound is used.

Examples of the alkali metal compound include sodium hydroxide, potassium hydroxide, sodium carbonate, potassium carbonate, sodium hydrogen carbonate, and sodium salts and potassium salts of a dihydric phenol. Examples of the alkali earth metal compound include calcium hydroxide, barium hydroxide and magnesium hydroxide. Examples of nitrogen-containing basic compound include tetramethylammonium hydroxide, tetarethylammonium hydroxide, tetrabutylammonium hydroxide, trimethylamine and triethylamine. They may be used alone or in combination of two or more. Out of these, a combination of a nitrogen-containing basic compound and an alkali metal compound is preferably used.

The amount of the polymerization catalyst is preferably 1×10⁻⁹ to 1×10⁻³ equivalent, more preferably 1×10⁻⁸ to 5×10⁻⁴ equivalent based on 1 mol of the diester carbonate (component C). The reaction system is preferably maintained in a gas atmosphere inactive to raw materials, a reaction mixture and a reaction product, such as nitrogen. Inert gases except for nitrogen include argon. Additives such as an antioxidant may be further added as required.

A catalyst deactivator may also be added to the polycarbonate resin obtained by the above production process. Known catalyst deactivators may be used effectively as the catalyst deactivator. Out of these, ammonium salts and phosphonium salts of sulfonic acid are preferred, and the above salts of dodecylbenzenesulfonic acid such as tetrabutylphosphonium salts of dodecylbenzenesulfonic acid and the above salts of paratoluenesulfonic acid such as tetrabutylammonium salts of paratoluenesulfonic acid are more preferred. Methyl benzenesulfonate, ethyl benzenesulfonate, butyl benzenesulfonate, octyl benzenesulfonate, phenyl benzenesulfonate, methyl paratoluenesulfonate, ethyl paratoluenesulfonate, butyl paratoluenesulfonate, octyl paratoluenesulfonate and phenyl paratoluenesulfonate are preferably used as the ester of sulfonic acid. Out of these, tetrabutylphosphonium salts of dodecylbenzenesulfonic acid are most preferably used. The amount of the catalyst deactivator is preferably 0.5 to 50 mols, more preferably 0.5 to 10 mols, much more preferably 0.8 to 5 mols based on 1 mol of the polymerization catalyst selected from an alkali metal compound and/or an alkali earth metal compound.

The polycarbonate resin of the present invention may be copolymerized with an aliphatic diol and/or an aromatic bisphenol. The amount of the aliphatic diol and/or the aromatic bisphenol is 70 mol % or less, preferably 50 mol % or less, more preferably 35 mol % or less of the whole hydroxy component. They may be used alone or in combination of two or more.

Examples of the aliphatic diol include linear diols such as ethylene glycol, 1,3-propanediol, 1,4-butanediol, 1,5-pentanediol and 1,6-hexanediol, and alicyclic diols such as cyclohexanediol, cyclohexanedimethanol and terpene-based dimethylol. Out of these, 1,3-propanediol, 1,4-butanediol, hexanediol, cyclohexanedimethanol, Spiro glycol and terpene-based dimethylol are preferred, and 1,3-propaneidol, 1,4-butanediol and terpene-based dimethylol are particularly preferred as they may be derived from biogenic matter.

Examples of the aromatic bisphenol include 2,2-bis(4-hydroxyphenyl)propane (commonly known as “bisphenol A”), 1,1-bis(4-hydroxyphenyl)cyclohexane, 1,1-bis(4-hydroxyphenyl)-3,3,5-trimethylcyclohexane, 4,4′-(m-phenylenediisopropylidene)diphenol, 9,9-bis(4-hydroxy-3-methylphenyl)fluorene, 2,2-bis(4-hydroxy-3-methylphenyl)propane, 2,2-bis(4-hydroxyphenyl)-4-methylpentane, 1,1-bis(4-hydroxyphenyl)decane and 1,3-bis{2-(4-hydroxyphenyl)propyl}benzene. Out of these, 2,2-bis(4-hydroxyphenyl)propane, 4,4′-(m-phenylenediisopropylidene)diphenol, 2,2-bis(4-hydroxyphenyl)-4-methylpentane and 1,1-bis(4-hydroxyphenyl)decane are particularly preferred.

### (Other Components)

Various functionalizing agents may be added to the resin composition of the present invention according to application purpose. The agents include a heat stabilizer, a stabilizing aid, a plasticizer, an antioxidant, an optical stabilizer, a nucleating agent, a heavy metal inactivating agent, a flame retardant, a lubricant, an antistatic agent and an ultraviolet absorbent.

Further, the polycarbonate resin of the present invention may be combined with an organic or inorganic filler or fiber to be used as a composite according to application purpose. Examples of the filler include carbon, talc, mica, wollastonite, montmorillonite and hydrotalcite. Examples of the fiber include natural fibers such as kenaf, synthetic fibers, glass fibers, quartz fibers and carbon fibers.

The resin composition of the present invention may be mixed with, for example, an aliphatic polyester, an aromatic polyester, an aromatic polycarbonate resin, a polyamide, polystyrene, a polyolefin, a polyacryl, ABS, a polyurethane or a polymer derived from biogenic matter such as polylactic acid to be alloyed.

### <Molded Article>

The present invention includes a molded article formed from the above polycarbonate resin. The molded article of the present invention can be obtained by injection molding. According to purpose, injection molding methods such as injection compression molding, injection press molding, gas assist injection molding, foam molding (including what comprises the injection of a super-critical fluid), insert molding, in-mold coating molding, insulated runner molding, quick heat and cool molding, two-color molding, sandwich molding and super high-speed injection molding may be employed to obtain the molded article. The advantages of these molding methods have already been widely known. Both cold-runner systems and hot-runner systems may be used.

The molded article of the present invention may be a profile extrusion molded article, a sheet or a film obtained by extrusion molding. For the molding of a sheet or a film, an inflation, calendering or casting method may be used. Further, the resin composition may be molded into a heat shrinkable tube by carrying out specific stretching operation. The resin composition of the present invention can be formed into a molded article by rotational molding or blow molding.

The molded article of the present invention is excellent in transparency and color. The molded article of the present invention has an arithmetic average surface roughness (Ra) of 0.03 μm or less and a haze measured for a 2 mm-thick flat plate in accordance with JIS K7105 of preferably 0 to 20%, more preferably 0 to 15%.

The b value of the flat plate is preferably 0 to 14, more preferably 0 to 13, much more preferably 0 to 12. The b value can be measured by using the SE-2000 spectral color meter of Nippon Denshoku Industries Co., Ltd. (light source: C/2).

When the molded article of the present invention has a length of 100 mm, a width of 50 mm and a thickness of 4 mm, its dimensional change rate at the time of saturation water absorption is preferably 1.5% or less.

The molded article may be a film. The film can be used for optical purpose. The film of the present invention can be manufactured by a solution casting method in which a solution obtained by dissolving the polycarbonate resin of the present invention in a solvent is cast or a melt film forming method in which the polycarbonate resin of the present invention is molten and cast as it is.

To form a film by the solution casting method, a halogen-based solvent, especially methylene chloride is preferably used as a solvent from the viewpoints of versatility and production cost. A solution prepared by dissolving 10 parts by weight of the polycarbonate resin of the present invention in 15 to 90 parts by weight of a solvent containing 60 wt % or more of methylene chloride is preferred as a solution composition (dope). When the amount of the solvent is larger than 90 parts by weight, it may be difficult to obtain a cast film which is thick and has excellent surface smoothness and when the amount of the solvent is smaller than 15 parts by weight, the melt viscosity becomes too high, whereby it may be difficult to manufacture a film.

Besides methylene chloride, another solvent may be added as required as long as film formability is not impaired. Examples of the solvent include alcohols such as methanol, ethanol, 1-propanol and 2-propanol, halogen-based solvents such as chloroform and 1,2-dichloroethane, aromatic solvents such as toluene and xylene, ketone-based solvents such as acetone, methyl ethyl ketone and cyclohexanone, ester-based solvents such as ethyl acetate and butyl acetate, and ether-based solvents such as ethylene glycol dimethyl ether.

In the present invention, a film can be obtained by heating the dope to evaporate the solvent after the dope is cast over a support substrate. A glass substrate, a metal substrate such as stainless steel or ferro type substrate, or a plastic substrate such as PET substrate is used as the support substrate, and the dope is cast over the support substrate uniformly with a doctor blade. A method in which the dope is continuously extruded onto a belt-like or drum-like support substrate from a die is commonly used in the industry.

Preferably, the dope cast over the support substrate is gradually heated from a low temperature to be dried so that foaming does not occur, most of the solvent is removed by heating so as to separate a self-supporting film from the support substrate, and further the film is heated from both sides to be dried so as to remove the residual solvent. Since it is fairly possible that stress is applied to the film by a dimensional change caused by heat shrinkage in the drying step after the film is removed from the substrate, attention must be paid to the drying temperature and the film fixing conditions for film formation which requires the precise control of optical properties like an optical film for use in liquid crystal displays. In general, it is preferred that the film should be dried by elevating the temperature from (Tg −100° C.) to Tg of the polycarbonate in use stepwise in the drying step after removal. When the film is dried at a temperature higher than Tg, the thermal deformation of the film occurs disadvantageously, and when the film is dried at a temperature lower than (Tg −100° C.), the drying temperature becomes too slow disadvantageously.

The amount of the residual solvent contained in the film obtained by the solution casting method is preferably 2 wt % or less, more preferably 1 wt % or less. When the amount is larger than 2 wt %, the glass transition point of the film greatly lowers disadvantageously.

To form a film by the melt film forming method, a melt solution is generally extruded from a T die to form a film. The film forming temperature which can be determined by the molecular weight, Tg and melt flow characteristics of the polycarbonate is generally 180 to 350° C., preferably 200 to 320° C. When the temperature is too low, the viscosity becomes high, whereby the orientation and stress distortion of the polymer may remain and when the temperature is too high, problems such as thermal deterioration, coloring and the formation of a die line (streak) from the T die may occur.

The thickness of the unstretched film obtained as described above which is not particularly limited and may be determined according to purpose is preferably 10 to 300 μm, more preferably 20 to 200 μm from the viewpoints of film production, physical properties such as toughness and cost.

The polycarbonate resin of the present invention constituting the film has a photoelastic constant of preferably 60×10⁻¹² Pa⁻¹ or less, more preferably 50×10⁻¹² Pa⁻¹ or less. When the photoelastic constant is higher than 60×10⁻¹² Pa⁻¹, a phase difference may be produced by tension generated when the optical film is laminated or by stress generated by a difference in dimensional stability between the polycarbonate resin and another material, whereby long-term stability may deteriorate due to the occurrence of a phenomenon such as light leakage or the reduction of contrast.

The wavelength dispersion of the phase difference values of the film of the present invention satisfies preferably the following expression (i), more preferably the following expression (ii).

1.010<R(450)/R(550)<1.070 (i)

1.010<R(450)/R(550)<1.060 (ii)

R(450) and R(550) are phase difference values within the film plane at wavelengths of 450 nm and 550 nm, respectively. When a phase difference film having a small wavelength dispersion of phase difference values is used, a film having excellent view angle characteristics and contrast in the VA (vertical alignment) mode of a liquid crystal display is obtained.

The value (Δn=R(550)/film thickness (μm)) obtained by dividing the phase difference by the thickness of the film of the present invention satisfies preferably the following expression (iii), more preferably the following expression (iv) while it is unstretched.

Δn<0.3×10⁻³ (iii)

Δn<0.25×10⁻³ (iv)

The lower limit is not particularly limited as long as it is larger than “0”.

The film of the present invention is preferably obtained by stretching the unstretched film by a known stretching method such as monoaxial stretching or biaxial stretching to orient the polymer. The film obtained by this stretching can be used as a phase difference film for liquid crystal displays. The stretching temperature is generally close to Tg of the polymer, specifically (Tg −20° C.) to (Tg +20° C.), and the draw ratio is generally 1.02 to 3 times in the case of monoaxial stretching in the longitudinal direction. The thickness of the stretched film is preferably 20 to 200 μm.

One of the preferred phase difference films obtained by the present invention is a phase difference film having a phase difference R(550) within the film plane at a wavelength of 550 nm which satisfies the following expression (1) and a film thickness of 10 to 150 μm.

100 nm<R(550)<2000 nm (1)

The phase difference R is defined by the following equation (5) and indicates a phase delay of light passing in a direction perpendicular to the film.

R=(nₓ−nₓ)×d (5)

[In the above equation, nₓ is the refractive index of a delay phase axis (axis having the highest refractive index) within the film plane, n_{y} is a refractive index in a direction perpendicular to nₓ within the film plane, and d is the thickness of the film.]

R(550) is more preferably 100 to 600 nm. The thickness of the film is more preferably 30 to 120 μm, much more preferably 30 to 100 μm. The phase difference film may be formed by monoaxial stretching or biaxial stretching and is suitable for use as a ¼λ plate, a ½λ plate or a λ plate.

Another preferred phase difference film has a phase difference R(550) within the film plane at a wavelength of 550 nm and a phase difference Rth(550) in the film thickness direction which satisfy the following expressions (2) and (3), respectively, and a film thickness of 10 to 150 μm.

0 nm<R(550)<150 nm (2)

100 nm<Rth(550)<400 nm (3)

(In the above expressions, Rth(550) is a phase difference value in the film thickness direction at a wavelength of 550 nm and is defined by the following equation (4).)

Rth={(nₓ+n_{y})/2−n_{z}}×d (4)

(In the above equation, nₓ and n_{y} are refractive indices in the x-axis and y-axis directions within the film plane, respectively, n_{z} is a refractive index in the thickness direction perpendicular to the x-axis and y-axis directions, and d is the thickness of the film.)

The film can be manufactured by biaxial stretching.

The film which is made of the resin of the present invention having characteristic properties which satisfy the above range of Δn easily produces a phase difference after stretching, has high phase difference controllability and is suitable for industrial application.

The film of the present invention has a total light transmittance of preferably 80% or more, more preferably 85% or more. The haze value of the film of the present invention is preferably 5% or less, more preferably 3% or less. Since the film of the present invention has excellent transparency, it is suitable for use as an optical film.

The film of the present invention may be used alone or two or more of the films may be laminated together. It may be combined with an optical film made of another material. It may be used as a protective film for polarizing plates or a transparent substrate for liquid crystal displays.

### EXAMPLES

The following examples are provided for the purpose of further illustrating the present invention but are in no way to be taken as limiting. “Parts” in the examples means parts by weight and “%” means wt %. Evaluations were made by the following methods.

(1) Specific Viscosity (ηₛₚ)

A pellet was dissolved in methylene chloride to a concentration of 0.7 g/dL so as to measure the specific viscosity of the resulting solution at 20° C. with an Ostwald's viscosimeter (RIGO AUTO VISCOSIMETER TYPE VMR-0525·PC). The specific viscosity (ηₛₚ) was obtained from the following equation.

ηₛₚ=t/t₀−1

t: flow time of a specimen solution
t₀: flow time of a solvent alone

### (2) Terminal Modification Group Content

¹H-NMR of the pellet in a heavy chloroform solution was measured with the JNM-AL400 of JEOL LTD. to obtain a terminal modification group content from the integral ratio of a specific proton derived from the main chain carbonate constituent unit and a specific proton derived from a hydroxyl-terminated compound. The terminal modification group content is the ratio (mol %) of the hydroxyl-terminated compound to the main chain carbonate constituent unit.

### (3) Glass Transition Temperature (Tg)

This was measured with the DSC (Model DSC2910) of TA Instruments Co., Ltd. by using the pellet.

### (4) 5% Weight Loss Temperature (Td)

This was measured with the TGA (Model TGA2950) of TA Instruments Co., Ltd. by using the pellet.

### (5) Moldability

A pellet was injection molded by means of the JSWJ-75EIII of The Japan Steel Works, Ltd. to evaluate the shape of a 2 mm-thick molded plate visually (mold temperature: 70 to 90° C., molding temperature: 220 to 260° C.)

### Moldability

o: no turbidity, cracking, shrinkage and silver streak by decomposition is seen
x: turbidity, cracking, shrinkage and silver streak by decomposition are seen

### (6) Contact Angle

The contact angle with pure water of the 2 mm-thick molded plate was measured by means of the drip type contact angle meter of Kyowa Interface Science Co., Ltd.

### (7) Water Absorption Coefficient

24 hours after a 2 mm-thick molded plate which had been dried at 100° C. for 24 hours in advance was immersed in 25° C. water, the weight of the molded plate was measured to calculate its water absorption coefficient from the following equation.

Water absorption coefficient={weight of sample plate (after water absorption)−weight of sample plate (before water absorption)}/weight of sample plate (before water absorption)×100 (wt %)

### (8) Film Thickness

The thickness of the film was measured by means of the film thickness meter of Mitutoyo Corporation.

### (9) Photoelastic Constant

A film having a width of 1 cm and a length of 6 cm was prepared, and the phase differences for light having a wavelength of 550 nm under no load and under loads of 1N, 2N and 3N of this film were measured with the M220 spectroscopic ellipsometer of JASCO Corporation Co., Ltd. to calculate (phase difference)×(film width)/(load) so as to obtain the photoelastic constant of the film.

### (10) Total Light Transmittance and Haze Value of Film

They were measured with the NDH-2000 turbidimeter of Nippon Denshoku Industries Co., Ltd.

(11) Phase Difference Values (R(450)), R(550)) and their Wavelength Dispersion (R(450)/R(550)

They were measured at wavelengths of 450 nm and 550 nm with the M220 spectroscopic ellipsometer of JASCO Corporation. The phase difference values for light vertically incident upon the film plane were measured.

### (12) Phase Difference Value Rth in Film Thickness Direction

The M220 spectroscopic ellipsometer of JASCO Corporation. was used for measurement at a wavelength of 550 nm. The in-plane phase difference value R was obtained by measuring light incident upon the film plane at a right angle. The phase difference value Rth in the film thickness direction was obtained by measuring phase difference values at each angle by changing the angle between incident light and the film plane little by little, curve fitting the obtained values with the known formula of an index ellipsoid so as to obtain 3-D refractive indices nₓ, n_{y} an n_{z}, and inserting them into the equation Rth={(nₓ+n_{y})/2-n_{z}}×d. Since the average refractive index of the film was required, it was measured by means of the Abbe refractometer 2-T of Atago Co., Ltd.

### (13) OH Value

¹H-NMR of a pellet in a heavy chloroform solution was measured by means of the JNM-AL400 of JEOL Corporation to obtain the OH value from the specific proton of a hydroxyl terminal derived from a compound represented by the formula (5) and the specific proton of a terminal group derived from a compound (diester carbonate or another specific compound) except for the compound represented by the formula (5) based on the following equation.

OH value=Rₘ×R_{OH}×17
Rₘ: {1000000/polymerization degree (weight average molecular weight)}×2
R_{OH}: ratio to all terminal groups of a hydroxyl-terminated compound obtained from the integral ratio of ¹H-NMR (a hydroxy compound terminal group derived from the compound represented by the formula (5) and a terminal group derived from a compound except for the compound represented by the formula (5) such as diester carbonate)

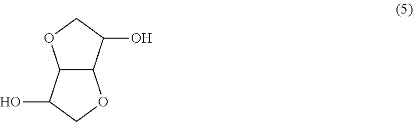

### (14) Biogenic Matter Content

The content of biogenic matter was measured from a biogenic matter content test based on radiocarbon concentration (percent modern carbon; C14) in accordance with ASTM D6866 05.

### (15) Molecular Weight Retention Under Wet Heat Condition

After a pellet whose weight average molecular weight (Mw) had been measured by means of the GPC (gel permeation chromatography) (column temperature of 40° C., chloroform solvent) of Polymer Laboratories Co., Ltd. through comparison between standard polystyrene and the sample was left at 120° C. and 100% RH for 11 hours, its weight average molecular weight was measured. After the pellet was left at 120° C. and at a relative humidity lower than 0.1% RH for 15 days, its weight average molecular weight was measured.

Molecular weight retention=molecular weight of pellet after wet heat test/molecular weight of pellet before wet heat test×100(%)

### (16) Saturation Water Absorption Coefficient

A molded plate having a length of 60 mm, a width of 60 mm and a thickness of 1 mm which had been dried at 100° C. for 24 hours was immersed in 23° C. water and taken out every day to measure its weight so as to calculate its water absorption coefficient from the following equation. The saturation water absorption coefficient is a water absorption coefficient when the weight of the above molded plate does not increase any more by water absorption.

Water absorption coefficient=(weight of molded plate after water absorption−weight of molded plate before water absorption)/weight of molded plate before water absorption×100(%)

### (17) Dimensional Change Rate

A molded plate having a length of 100 mm, a width of 50 mm and a thickness of 4 mm which had been dried at 100° C. for 24 hours was immersed in 23° C. water and taken out regularly to measure its weight. The time when the weight of the above molded plate does not increase any more by water absorption was taken as saturation water absorption time, and the dimensional change at this time was measured. The dimensional change rate is represented by the following equation, and the average of a long side dimensional change and a short side dimensional change is shown as the dimensional change rate of this molded plate.

Dimensional change rate={length of long side (short side) after water absorption−length of long side (short side) before water absorption}/length of long side (short side) before water absorption×100(%)

### Example 1

731 parts by weight (5.00 mols) of isosorbide, 2,206 parts by weight (10.30 mols) of diphenyl carbonate, 1,141 parts by weight (5.00 mols) of 2,2-bis(4-hydroxyphenyl)propane and 81 parts by weight (0.30 mol) of stearyl alcohol were fed to a reactor, and 1.0 part by weight (1×10⁻⁴ mol based on 1 mol of the diphenyl carbonate component) of tetramethylammonium hydroxide and 0.9×10⁻³ part by weight (0.2×10⁻⁶ mol based on 1 mol of the diphenyl carbonate component) of sodium hydroxide as polymerization catalysts were fed to the reactor and dissolved at 180° C. in a nitrogen atmosphere.

The inside pressure of the reactor was gradually reduced to 13.3×10⁻³ MPa over 30 minutes under agitation while the formed phenol was distilled off. After a reaction was carried out in this state for 20 minutes, the temperature was raised to 200° C., the pressure was gradually reduced over 20 minutes to carry out the reaction at 4.00×10⁻³ MPa for 20 minutes while the phenol was distilled off, and the temperature was further raised to 220° C. to carry out the reaction for 30 minutes and then to 250° C. to carry out the reaction for 30 minutes.

After the pressure was gradually reduced to continue the reaction at 2.67×10⁻³ MPa for 10 minutes and at 1.33×10⁻³ MPa for 10 minutes and further reduced to 4.00×10⁻⁵ MPa, the temperature was gradually raised to 250° C., and the reaction was carried out at 250° C. and 6.66×10⁻⁵ MPa for 1 hour in the end. The polymer after the reaction was pelletized to obtain a pellet having a specific viscosity of 0.26. The other evaluation results of this pellet are shown in Table 1.

### Example 2

906 parts by weight (6.20 mols) of isosorbide, 868 parts by weight (3.80 mols) of 2,2-bis(4-hydroxyphenyl)propane and 122 parts by weight (0.40 mol) of pentadecylphenol were fed to a reactor equipped with a thermometer and a stirrer, the inside of the reactor was substituted by nitrogen, and 8,900 parts by weight of well dried pyridine and 32,700 parts by weight of methylene chloride were added to dissolve these substances. 1,420 parts by weight (14.30 mols) of phosgene was blown for 100 minutes under agitation at 20° C. After the blowing of phosgene, stirring was carried out for about 20 minutes to terminate the reaction. After the end of the reaction, the product was diluted with methylene chloride, pyridine was neutralized with hydrochloric acid to be removed, the obtained product was rinsed with water repeatedly until its conductivity became almost equal to that of ion exchange water, and methylene chloride was evaporated to obtain a powder. The obtained powder was melt extruded into a strand which was then cut to obtain a pellet. This pellet had a specific viscosity of 0.27. The other evaluation results of this pellet are shown in Table 1.

### Example 3

A pellet was obtained by polymerization in the same manner as in Example 1 except that 1,242 parts by weight (8.50 mols) of isosorbide, 402 parts by weight (1.50 mols) of 1,1-bis(4-hydroxyphenyl)cyclohexane, 2,185 parts by weight (10.20 mols) of diphenyl carbonate and 61 parts by weight (0.60 mol) of 1-hexanol were used. The obtained pellet had a specific viscosity of 0.32. The other evaluation results of this pellet are shown in Table 1.

### Example 4

A pellet was obtained by polymerization in the same manner as in Example 1 except that 1,374 parts by weight (9.40 mols) of isosorbide, 196 parts by weight (0.60 mols) of 1,1-bis(4-hydroxyphenyl)decane, 2,164 parts by weight (10.10 mols) of diphenyl carbonate and 11 parts by weight (0.01 mol) of one-end reactive polydimethylsiloxane represented by the following formula (16) (n=9) were used. The obtained pellet had a specific viscosity of 0.34. The other evaluation results of this pellet are shown in Table 1.

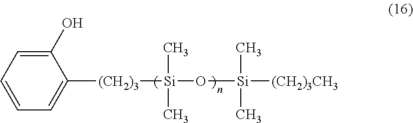

### Example 5

A pellet was obtained by polymerization in the same manner as in Example 1 except that 1,242 parts by weight (8.50 mols) of isosorbide, 405 parts by weight (1.50 mols) of 2,2-bis(4-hydroxyphenyl)-4-methylpentane, 2,164 parts by weight (10.10 mols) of diphenyl carbonate and 19 parts by weight (0.03 mol) of 4,4,5,5,6,6,7,7,8,8,9,9,10,10,11,11,11-heptadecafluoroun decyl 4-hydroxybenzoate (the following formula (17)) were used. The obtained pellet had a specific viscosity of 0.39. The other evaluation results of this pellet are shown in Table 1.

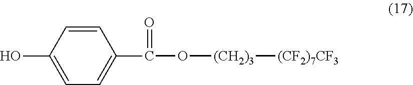

### Example 6

A pellet was obtained by polymerization in the same manner as in Example 1 except that 1,023 parts by weight (7.00 mols) of isosorbide, 228 parts by weight (3.00 mols) of 1,3-propanediol, 2,185 parts by weight (10.20 mols) of diphenyl carbonate and 81 parts by weight (0.30 mol) of stearyl alcohol were used. The obtained pellet had a specific viscosity of 0.31. The other evaluation results of this pellet are shown in Table 1.

### Example 7

A pellet was obtained by polymerization in the same manner as in Example 1 except that 1,374 parts by weight (9.40 mols) of isosorbide, 85 parts by weight (0.60 mols) of 1,4-cyclohexanedimethanol, 2,185 parts by weight (10.20 mols) of diphenyl carbonate and 122 parts by weight (0.40 mol) of pentadecylphenol were used. The obtained pellet had a specific viscosity of 0.31. The other evaluation results of this pellet are shown in Table 1.

### Comparative Example 1

1,461 parts by weight (10.00 mols) of isosorbide and 2,142 parts by weight (10.00 mols) of diphenyl carbonate were fed to a reactor, and 1.0 parts by weight (1×10⁻⁴ mol based on 1 mol of the diphenyl carbonate component) of tetramethylammonium hydroxide and 5.4×10⁻³ part by weight (0.2×10⁻⁶ mol based on 1 mol of the diphenyl carbonate component) of 2,2-bis(4-hydroxyphenyl)propane disodium salt as polymerization catalysts were fed to the reactor and dissolved at 180° C. in a nitrogen atmosphere.

The inside pressure of the reactor was gradually reduced to 13.3×10⁻³ MPa over 30 minutes under agitation while the formed phenol was distilled off. After a reaction was carried out in this state for 20 minutes, the temperature was raised to 200° C., the pressure was gradually reduced over 20 minutes to carry out the reaction at 4.00×10⁻³ MPa for 20 minutes while the phenol was distilled off, and the temperature was further raised to 220° C. to carry out the reaction for 30 minutes and then to 250° C. to carry out the reaction for 30 minutes.

After the pressure was gradually reduced to continue the reaction at 2.67×10⁻³ MPa for 10 minutes and at 1.33×10⁻³ MPa for 10 minutes and further reduced to 4.00×10⁻⁵ MPa, the temperature was gradually raised to 260° C., and the reaction was carried out at 260° C. and 6.66×10⁻⁵ MPa for 2 hours in the end. The polymer after the reaction was pelletized to obtain a pellet having a specific viscosity of 0.36. In this case, since a hydroxy compound which could cause terminal modification was not added, the content of the terminal modifying group was 0 mol %. The other evaluation results of this pellet are shown in Table 1.

### Comparative Example 2

A pellet was obtained by polymerization in the same manner as in Example 1 except that 1,608 parts by weight (11.00 mols) of isosorbide, 2,474 parts by weight (11.55 mols) of diphenyl carbonate and 268 parts by weight (0.88 mol) of 3-pentadecylphenol were used. The obtained pellet had a specific viscosity of 0.16 and a terminal modifying group content of 7.4 mol %. The other evaluation results of this pellet are shown in Table 1.

TABLE 1

| Components | | Unit | Ex. 1 | Ex. 2 | Ex. 3 | Ex. 4 | Ex. 5 |
|---|---|---|---|---|---|---|---|
| Component A | isosorbide | mol | 5.00 | 6.20 | 8.50 | 9.40 | 8.50 |
| Component B | 2,2-bis(4-hydroxyphenyl)propane | mol | 5.00 | 3.80 | | | |
| | 1,1-bis(4-hydroxyphenyl)cyclohexane | mol | | | 1.50 | | |
| | 1,1-bis(4-hydroxyphenyl)decane | mol | | | | 0.60 | |
| | 2,2-bis(4-hydroxyphenyl)-4-methylpentane | mol | | | | | 1.50 |
| | 1,3-propanediol | mol | | | | | |
| | 1,4-cyclohexanedimethanol | mol | | | | | |
| | 1,6-hexandio | | | | | | |
| | 3,9-bis(2-hydroxy-1,1-dimethylethyl)-2,4,8,10- | | | | | | |
| | tetraoxaspiro(5,5)undecane | | | | | | |
| Component C | diphenyl carbonate | mol | 10.30 | — | 10.20 | 10.10 | 10.10 |
| Component D | stearyl alcohol | mol | 0.30 | | | | |
| | Pentadecyl phenol | mol | | 0.40 | | | |
| | 1-hexanol | mol | | | 0.60 | | |
| | formula (16) | mol | | | | 0.01 | |
| | formula (17) | mol | | | | | 0.03 |
| Evaluation | specific viscosity | — | 0.26 | 0.27 | 0.32 | 0.34 | 0.39 |
| results | OH value | — | 675 | 537 | 381 | 761 | 792 |
| | Terminal modifying group content | mol % | 2.9 | 3.8 | 5.7 | 0.1 | 0.3 |
| | Glass transition temperature | ° C. | 149 | 152 | 163 | 149 | 155 |
| | 5% weight loss temperature | ° C. | 367 | 358 | 358 | 355 | 345 |
| | Moldability | — | ◯ | ◯ | ◯ | ◯ | ◯ |
| | Contact angle | ° | 80 | 82 | 75 | 95 | 93 |
| | Water absorption coefficient(24 h) | wt % | 0.37 | 0.42 | 0.57 | 0.64 | 0.57 |
| | Biogenic matter content | % | 32 | 42 | 62 | 73 | 63 |

| Components | | unit | Ex. 6 | Ex. 7 | C. Ex. 1 | C. Ex. 2 |
|---|---|---|---|---|---|---|
| Component A | isosorbide | mol | 7.00 | 9.40 | 10.00 | 11.00 |
| Component B | 2,2-bis(4-hydroxyphenyl)propane | mol | | | | |
| | 1,1-bis(4-hydroxyphenyl)cyclohexane | mol | | | | |
| | 1,1-bis(4-hydroxyphenyl)decane | mol | | | | |
| | 2,2-bis(4-hydroxyphenyl)-4-methylpentane | mol | | | | |
| | 1,3-propanediol | mol | 3.00 | | | |
| | 1,4-cyclohexanedimethanol | mol | | 0.60 | | |
| | 1,6-hexandio | | | | | |
| | 3,9-bis(2-hydroxy-1,1-dimethylethyl)-2,4,8,10- | mol | | | | |
| | tetraoxaspiro(5,5)undecane | | | | | |
| Component C | diphenyl carbonate | mol | 10.20 | 10.20 | 10.00 | 11.55 |
| Component D | stearyl alcohol | mol | 0.30 | | | |
| | Pentadecyl phenol | mol | | 0.40 | | 0.88 |
| | 1-hexanol | mol | | | | |
| | formula (16) | mol | | | | |
| | formula (17) | mol | | | | |
| Evaluation | specific viscosity | — | 0.31 | 0.31 | 0.36 | 0.16 |
| results | OH value | — | 778 | 622 | 2687 | 8433 |
| | Terminal modifying group content | mol % | 2.9 | 3.8 | 0 | 7.4 |
| | Glass transition temperature | ° C. | 116 | 130 | 165 | 126 |
| | 5% weight loss temperature | ° C. | 345 | 355 | 358 | 349 |
| | Moldability | — | ◯ | ◯ | X | X |
| | Contact angle | ° | 78 | 79 | 62 | 81 |
| | Water absorption coefficient(24 h) | wt % | 0.47 | 0.64 | 0.84 | 0.62 |
| | Biogenic matter content | % | 62 | 78 | 84 | 77 |

Ex.: Example

### Example 8

A film was obtained from the terminal modified polycarbonate resin obtained in Example 7 by using the KZW15-30MG film molding machine (of Technobell Co., Ltd.) and the KYA-2H-6 roll temperature control machine (of Kato Riki Mfg. Co., Ltd.) in accordance with a melt film forming method. The temperature of the cylinder of an extruder was kept at 220 to 260° C., and the roll temperature was set to 140 to 160° C. The physical properties of the obtained film are shown in Table 2.

### Comparative Example 3

A film was obtained from the Panlite® L1225 of Teijin Chemicals Ltd. which is a polycarbonate resin obtained from bisphenol A by using the KZW15-30MG film molding machine (of Technobell Co., Ltd.) and the KYA-2H-6 roll temperature control machine (of Kato Riki Mfg. Co., Ltd.) in accordance with the melt film forming method. The temperature of the cylinder of an extruder was kept at 260 to 300° C., and the roll temperature was set to 140 to 160° C. The physical properties of the obtained film are shown in Table 2. It is understood that this film has a higher photoelastic constant and a larger wavelength dispersion of phase difference values than those of the polycarbonate film of Example 8.

TABLE 2

| | | | Comparative |
|---|---|---|---|
| | Unit | Example 8 | Example 3 |
| Film thickness | μm | 80 | 139 |
| Photoelastic | ×10⁻¹² Pa⁻¹ | 24 | 81 |
| constant | | | |
| Total light | % | 92 | 91 |
| transmittance | | | |
| Haze | % | 0.5 | 0.3 |
| R(550) | nm | 6 | 44 |
| R(450)/R(550) | — | 1.026 | 1.071 |
| [symbol] n | ×10⁻³ | 0.08 | 0.32 |

### Examples 9 to 11

The unstretched terminal modified polycarbonate film obtained in Example 8 was monoaxially stretched at three different draw ratios at a stretching temperature of 150 to 160° C. by means of a stretching machine to obtain stretched films. The physical properties such as phase difference values and wavelength dispersions thereof of these stretched films are shown in Table 3.

### Example 12

The unstretched terminal modified polycarbonate film obtained in Example 8 was biaxially stretched simultaneously by means of a batch type simultaneous biaxial stretching machine. The draw ratio in one direction was 1.3 times, the draw ratio in the other direction was 1.4 times, and the stretching temperature was 140° C. The physical properties of the obtained biaxially stretched film are shown in Table 4.

### Comparative Examples 4 and 5

The polycarbonate film obtained in Comparative Example 3 was monoaxially stretched at two different draw ratios at a stretching temperature of 120° C. by means of a stretching machine to obtain stretched films. The physical properties such as phase difference values and wavelength dispersions thereof of these stretched films are shown in Table 3. As compared with the terminal modified polycarbonate films of Examples 9 to 11, the phase differences after stretching are hardly produced and the wavelength dispersion of phase difference values is large, whereby it is understood that these films are inferior in phase difference controllability.

TABLE 3

| | | | | Ex. | Ex. | | |
|---|---|---|---|---|---|---|---|
| | | unit | Ex. 9 | 10 | 11 | C. Ex. 4 | C. Ex. 5 |
| Stretching | Stretching | times | 1.2 | 1.5 | 2.2 | 1.2 | 1.5 |
| conditions | ratios | | | | | | |
| Film physical | film thickness | μm | 76 | 72 | 62 | 44 | 39 |
| properties | R(550) | nm | 162 | 475 | 1158 | 47 | 154 |
| | R(450)/ | | 1.019 | 1.025 | 1.025 | 1.025 | 1.038 |
| | R(550) | | | | | | |

Ex.: Example
C. Ex.: Comparative Example

TABLE 4

| | Unit | Ex. 12 |
|---|---|---|
| Film thickness | μm | 42 |
| R(550) | nm | 62 |
| Rth(50) | nm | 226 |

Ex.: Example

### Example 13

7,307 parts by weight (50 mols) of isosorbide and 10, 711 parts by weight (50 mols) of diphenyl carbonate were fed to a reactor, and 1.4 parts by weight (3×10⁻⁴ mol based on 1 mol of the diphenyl carbonate component) of tetramethylammonium hydroxide and 6.1×10⁻³ part by weight (3×10⁻⁶ mol based on 1 mol of the diphenyl carbonate component) of sodium hydroxide as polymerization catalysts were fed to the reactor and dissolved by heating at 180° C. at normal pressure in a nitrogen atmosphere. The inside pressure of the reactor was gradually reduced to 13.3×10^{-3 MPa over} 30 minutes under agitation while the formed phenol was distilled off. After a reaction was carried out in this state for 20 minutes, the temperature was raised to 200° C., the pressure was gradually reduced over 20 minutes to carry out the reaction at 4.00×10⁻³ MPa for 20 minutes while the phenol was distilled off, and the temperature was further raised to 220° C. to carry out the reaction for 30 minutes and then to 250° C. to carry out the reaction for 30 minutes. When the phenol was distilled off in an amount of 93% (105 g) of the theoretical distillation amount, the inside of the reactor was returned to normal pressure with nitrogen, 321 parts by weight (1.5 mols) of diphenyl carbonate was added, and the pressure was gradually reduced to 2.67×10⁻³ MPa. The reaction was continued at this pressure for 10 minutes and then at 1.33×10⁻³ MPa for 10 minutes, when the pressure was further reduced to 4.00×10⁻⁵ MPa, the temperature was gradually raised to 250° C., and the reaction was carried out at 250° C. and 6.66×10⁻⁵ MPa for 1 hour in the end. As a result, a polymer having a specific viscosity of 0.35 was obtained. The evaluation results of this polymer are shown in Table 5.

### Example 14

Raw materials were fed to carry out a polymerization reaction in the same manner as in Example 13, and a pellet having a specific viscosity of 0.32 was obtained by polymerization in the same manner as in Example 13 except that 642 parts by weight (3.0 mols) of diphenyl carbonate was further added during a reaction. The evaluation results are shown in Table 5.

### Example 15

A polymer having a specific viscosity of 0.34 was obtained by polymerization in the same manner as in Example 13 except that 6,210 parts by weight (42.5 mols) of isosorbide, 2,449 parts by weight (7.5 mols; melting point of 92° C.) of 1,1-bis(4-hydroxyphenyl)decane and 10,711 parts by weight (50 mols) of diphenyl carbonate were used to carry out a polymerization reaction and 321 parts by weight (1.5 mols) of diphenyl carbonate was further added during the reaction. The evaluation results of this polymer are shown in Table 5.

### Example 16

A polymer having a specific viscosity of 0.28 was obtained by polymerization in the same manner as in Example 13 except that 6,210 parts by weight (42.5 mols) of isosorbide, 2,020 parts by weight (7.5 mols; melting point of 154° C.) of 2,2-bis(4-hydroxyphenyl)-4-methylpentane and 10,711 parts by weight (50 mols) of diphenyl carbonate were used to carry out a polymerization reaction and 321 parts by weight (1.5 mols) of diphenyl carbonate was further added during the reaction. The evaluation results of this polymer are shown in Table 5.

### Example 17

A polymer having a specific viscosity of 0.25 was obtained by polymerization in the same manner as in Example 13 except that 4,969 parts by weight (34 mols) of isosorbide, 3,652 parts by weight (16 mols) of 2,2-bis(4-hydroxyphenyl)propane and 10,711 parts by weight (50 mols) of diphenyl carbonate were used to carry out a polymerization reaction and 321 parts by weight (1.5 mols) of diphenyl carbonate was further added during the reaction. The evaluation results of this polymer are shown in Table 5.

### Example 18

A polymer having a specific viscosity of 0.27 was obtained by polymerization in the same manner as in Example 13 except that 5,115 parts by weight (35 mols) of isosorbide, 1,142 parts by weight (15 mols) of 1,3-propanediol and 10,711 parts by weight (50 mols) of diphenyl carbonate were used to carry out a polymerization reaction and 321 parts by weight (1.5 mols) of diphenyl carbonate was further added during the reaction. The evaluation results of this polymer are shown in Table 5.

### Example 19

A polymer having a specific viscosity of 0.27 was obtained by polymerization in the same manner as in Example 13 except that 5,846 parts by weight (40 mols) of isosorbide, 1,442 parts by weight (10 mols) of cyclohexanedimethanol and 10,711 parts by weight (50 mols) of diphenyl carbonate were used to carry out a polymerization reaction and 321 parts by weight (1.5 mols) of diphenyl carbonate was further added during the reaction. The evaluation results of this polymer are shown in Table 5.

### Example 20

A polymer having a specific viscosity of 0.29 was obtained by polymerization in the same manner as in Example 13 except that 6,576 parts by weight (45 mols) of isosorbide, 1,520 parts by weight (5 mols) of 3,9-bis(2-hydroxy-1,1-dimethylethyl)-2,4,8,10-tetraoxaspiro(5,5)undecane and 10,711 parts by weight (50 mols) of diphenyl carbonate were used to carry out a polymerization reaction and 321 parts by weight (1.5 mols) of diphenyl carbonate was further added during the reaction. The evaluation results of this polymer are shown in Table 5.

### Example 21

A polymer having a specific viscosity of 0.28 was obtained by polymerization in the same manner as in Example 13 except that 5,846 parts by weight (40 mols) of isosorbide, 1,182 parts by weight (10 mols) of 1,6-hexanediol and 10,711 parts by weight (50 mols) of diphenyl carbonate were used to carry out a polymerization reaction and 321 parts by weight (1.5 mols) of diphenyl carbonate was further added during the reaction. The evaluation results of this polymer are shown in Table 5.

### Comparative Example 6

A polymer having a specific viscosity of 0.34 was obtained by polymerization in the same manner as in Example 13 except that 7,307 parts by weight (50 mols) of isosorbide and 10,711 parts by weight (50 mols) of diphenyl carbonate were fed to a reactor and diphenyl carbonate was not further added during the reaction. The evaluation results of this polymer are shown in Table 5.

### Comparative Example 7

A polymer having a specific viscosity of 0.12 was obtained by polymerization in the same manner as in Example 13 except that 7,307 parts by weight (50 mols) of isosorbide and 11,354 parts by weight (53 mols) of diphenyl carbonate were fed to a reactor and diphenyl carbonate was not further added during the reaction. The evaluation results of this polymer are shown in Table 5. Since the polymer was very fragile and could not be molded, its water absorption coefficient could not be measured.

TABLE 5

| | | Ex. | Ex. | Ex. | Ex. | Ex. | Ex. |
|---|---|---|---|---|---|---|---|
| | Unit | 13 | 14 | 15 | 16 | 17 | 18 |
| Isosorbide | mol | 50 | 50 | 42.5 | 42.5 | 34 | 35 |
| 2,2-bis(4-hydroxyphenyl)propane | mol | — | — | — | — | 16 | — |
| 1,1-bis(4-hydroxyphenyl)decane | mol | — | — | 7.5 | — | — | — |
| 2,2-bis(4-hydroxyphenyl)-4-methylpentane | mol | — | — | — | 7.5 | — | — |
| 1,3-propanediol | mol | — | — | — | — | — | 15 |
| Cyclohexanedimethanol | mol | — | — | — | — | — | — |
| 3,9-bis(2-hydroxy-1,1-dimethylethyl)-2,4,8,10- | mol | — | — | — | — | — | — |
| tetraoxaspiro(5,5)undecane | | | | | | | |
| 1,6-hexanediol | mol | — | — | — | — | — | — |
| Diphenyl carbonate first stage | mol | 50 | 50 | 50 | 50 | 50 | 50 |
| Diphenyl carbonate second stage | mol | 1.5 | 3.0 | 1.5 | 1.5 | 1.5 | 1.5 |
| Specific viscosity | None | 0.35 | 0.32 | 0.34 | 0.28 | 0.25 | 0.27 |
| Tg | ° C. | 160 | 157 | 124 | 135 | 147 | 125 |
| OH value | % | 636 | 588 | 983 | 1050 | 870 | 971 |
| Biogenic matter content | % | 84 | 82 | 62 | 65 | 50 | 62 |
| Molecular weight retention (after 11 hours) | % | 97 | 97 | 98 | 96 | 96 | 90 |
| Molecular weight retention (after 15 days) | % | 97 | 97 | 98 | 96 | 96 | 90 |
| Saturation water absorption coefficient | % | 4.7 | 4.3 | 1.8 | 3.0 | 2.2 | 1.8 |
| Dimensional change rate | % | 1.1 | 0.9 | 0.3 | 0.7 | 0.5 | 0.3 |

| | Unit | Ex. 19 | Ex. 20 | Ex. 21 | C. Ex. 6 | C. Ex. 7 |
|---|---|---|---|---|---|---|
| Isosorbide | mol | 40 | 45 | 40 | 50 | 50 |
| 2,2-bis(4-hydroxyphenyl)propane | mol | — | — | — | — | — |
| 1,1-bis(4-hydroxyphenyl)decane | mol | — | — | — | — | — |
| 2,2-bis(4-hydroxyphenyl)-4-methylpentane | mol | — | — | — | — | — |
| 1,3-propanediol | mol | — | — | — | — | — |
| Cyclohexanedimethanol | mol | 10 | — | — | — | — |
| 3,9-bis(2-hydroxy-1,1-dimethylethyl)-2,4,8,10- | mol | — | 5 | — | — | — |
| tetraoxaspiro(5,5)undecane | | | | | | |
| 1,6-hexanediol | mol | — | — | 10 | — | — |
| Diphenyl carbonate first stage | mol | 50 | 50 | 50 | 50 | 53 |
| Diphenyl carbonate second stage | mol | 1.5 | 1.5 | 1.5 | — | — |
| Specific viscosity | None | 0.27 | 0.29 | 0.28 | 0.34 | 0.12 |
| Tg | ° C. | 121 | 155 | 114 | 161 | 138 |
| OH value | | 351 | 416 | 324 | 3100 | 2000 |
| Biogenic matter content | % | 68 | 69 | 71 | 84 | 82 |
| Molecular weight retention (after 11 hours) | % | 94 | 96 | 95 | 78 | unmeasurable |
| Molecular weight retention (after 15 days) | % | 94 | 96 | 95 | 78 | unmeasurable |
| Saturation water absorption coefficient | % | 2.6 | 2.0 | 1.5 | 5.2 | unmeasurable |
| Dimensional change rate | % | 0.2 | 0.3 | 0.2 | 1.6 | unmeasurable |

Ex.: Example
C. Ex.: Comparative Example

### EFFECT OF THE INVENTION

The polycarbonate resin of the present invention contains a unit derived from biogenic matter in the main chain and has a high biogenic matter content. Although the polycarbonate resin of the present invention contains an ether diol component having high polarity, it has high moisture absorption resistance and is therefore excellent in the dimensional stability and wet heat stability of a molded article. The polycarbonate resin of the present invention is also excellent in heat resistance and heat stability. The polycarbonate resin of the present invention has low melt viscosity though it has a high biogenic matter content and is therefore excellent in moldability. The polycarbonate resin of the present invention has such high surface energy that it is hardly stained and has excellent abrasion resistance.

According to the production process of the present invention, there can be obtained a polycarbonate resin which contains a moiety derived from biogenic matter, is excellent in moisture absorption resistance, heat resistance, heat stability and moldability and has high surface energy.

The optical film of the present invention has a low photoelastic constant, high phase difference developability and phase difference controllability and excellent view angle characteristics as well as high heat resistance and heat stability.

### INDUSTRIAL FEASIBILITY

The polycarbonate resin of the present invention is used for various purposes, for example, optical parts such as optical sheets, optical disks, information disks, optical lenses and prisms, mechanical parts, construction materials, auto parts, electric and electronic parts, OA equipment parts, resin trays and tableware.

1. A polycarbonate resin which contains 30 to 100 mol % of a unit represented by the following formula (1) in all the main chains and has (i) a biogenic matter content measured in accordance with ASTM D6866 05 of 25 to 100%, (ii) a specific viscosity at 20° C. of a solution prepared by dissolving 0.7 g of the resin in 100 ml of methylene chloride of 0.2 to 0.6 and (iii) an OH value of 2.5×10³ or less.

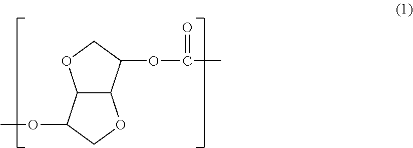

2. The polycarbonate resin according to claim 1 which contains a terminal group represented by the following formula (2) or (3) in an amount of 0.01 to 7 mol % based on the main chain. 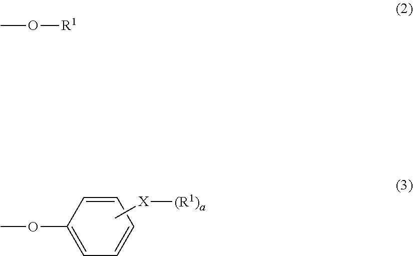
{In the above formulas (2) and (3), R¹ is an alkyl group having 4 to 30 carbon atoms, aralkyl group having 7 to 30 carbon atoms, perfluoroalkyl group having 4 to 30 carbon atoms, phenyl group or group represented by the following formula (4), X is at least one bond selected from the group consisting of a single bond, ether bond, thioether bond, ester bond, amino bond and amide bond, and a is an integer of 1 to 5.} 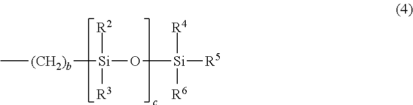
(In the above formula (4), R², R³, R⁴, R⁵ and R⁶ are each independently at least one group selected from the group consisting of an alkyl group having 1 to 10 carbon atoms, cycloalkyl group having 6 to 20 carbon atoms, alkenyl group having 2 to 10 carbon atoms, aryl group having 6 to 10 carbon atoms and aralkyl group having 7 to 20 carbon atoms, b is an integer of 0 to 3, and c is an integer of 4 to 100.)

3. The polycarbonate resin according to claim 1, wherein the unit of the formula (1) is a unit derived from isosorbide (1,4:3,6-dianhydro-D-sorbitol).

4. The polycarbonate resin according to claim 1 which has a water absorption coefficient at 23° C. after 24 hours of 0.75% or less.

5. The polycarbonate resin according to claim 1 which has a molecular weight retention at 120° C. and 100% RH after 11 hours of 80% or more.

6. A process for producing a polycarbonate resin by reacting (A) an ether diol (component A) represented by the following formula (5), (B) a diol and/or a diphenol (component B) except for the component A, (C) a diester carbonate (component C), and (D) 0.01 to 7 mol % based on the total of the component A and the component B of a hydroxy compound (component D) represented by the following formula (6) or (7). 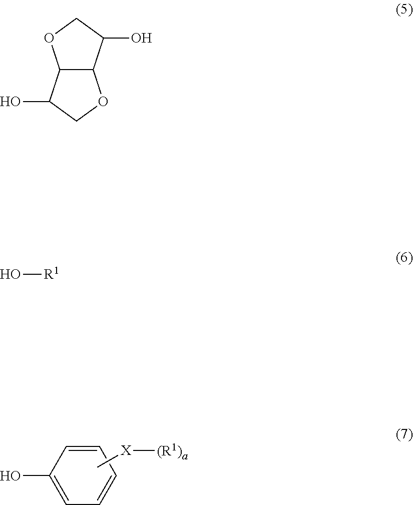
{In the above formulas (6) and (7), R¹ is an alkyl group having 4 to 30 carbon atoms, aralkyl group having 7 to 30 carbon atoms, perfluoroalkyl group having 4 to 30 carbon atoms, phenyl group or group represented by the following formula (4), X is at least one bond selected from the group consisting of a single bond, ether bond, thioether bond, ester bond, amino bond and amide bond, and a is an integer of 1 to 5.} 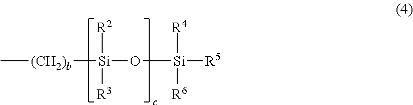
(In the above formula (4), R², R³, R⁴, R⁵ and R⁶ are each independently at least one group selected from the group consisting of an alkyl group having 1 to 10 carbon atoms, cycloalkyl group having 6 to 20 carbon atoms, alkenyl group having 2 to 10 carbon atoms, aryl group having 6 to 10 carbon atoms and aralkyl group having 7 to 20 carbon atoms, b is an integer of 0 to 3, and c is an integer of 4 to 100.)

7. The production process according to claim 6, wherein the amount of the diester carbonate (component C) is 1.05 to 0.97 in terms of molar ratio (component C/(component A+component B)) based on the total of the component A and the component B.

8. The production process according to claim 6, wherein the components A to D are reacted by heating at normal pressure and then melt polycondensed under reduced pressure by heating at 180 to 280° C. in the presence of a polymerization catalyst.

9. The production process according to claim 6, wherein at least one compound selected from the group consisting of a nitrogen-containing basic compound, an alkali metal compound and an alkali earth metal compound is used as the polymerization catalyst.

10. The production process according to claim 6, wherein the ether diol (component A) is isosorbide (1,4:3,6-dianhydro-D-sorbitol).

11. A process for producing a polycarbonate resin by reacting (A) an ether diol (component A) represented by the following formula (5), (B) a diol and/or a diphenol (component B) except for the component A, and (E) phosgene (component E) in an inactive solvent in the presence of an acid binder, wherein
(D) a hydroxy compound (component D) represented by the following formula (6) or (7) is reacted as an end-sealing agent. 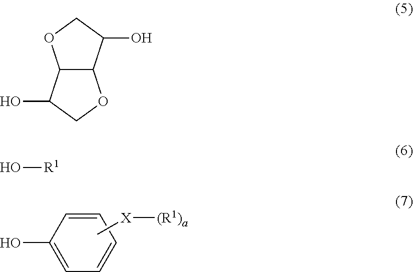
(In the above formulas (6) and (7), R¹ is an alkyl group having 4 to 30 carbon atoms, aralkyl group having 7 to 30 carbon atoms, perfluoroalkyl group having 4 to 30 carbon atoms, phenyl group or group represented by the following formula (4), X is at least one bond selected from the group consisting of a single bond, ether bond, thioether bond, ester bond, amino bond and amide bond, and a is an integer of 1 to 5.) 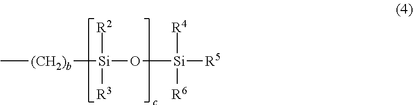
(In the above formula (4), R², R³, R⁴, R⁵ and R⁶ are each independently at least one group selected from the group consisting of an alkyl group having 1 to 10 carbon atoms, cycloalkyl group having 6 to 20 carbon atoms, alkenyl group having 2 to 10 carbon atoms, aryl group having 6 to 10 carbon atoms and aralkyl group having 7 to 20 carbon atoms, b is an integer of 0 to 3, and c is an integer of 4 to 100.)

12. The production process according to claim 11, wherein the acid binder is at least one selected from the group consisting of pyridine, quinolone and dimethylaniline.

13. The production process according to claim 11, wherein the ether diol (component A) is isosorbide (1,4:3,6-dianhydro-D-sorbitol).

14. A process for producing a polycarbonate resin by reacting a dihydroxy component consisting of 30 to 100 mol % of an ether diol (component A) represented by the following formula (5) and 0 to 70 mol % of a diol or a diphenol (component B) except for the ether diol (component A) with a diester carbonate component (component C) by heating at normal pressure and then melt polycondensing the reaction product under reduced pressure by heating at 180 to 280° C. in the presence of a polymerization catalyst, wherein
(i) the weight ratio of the component C to the dihydroxy component (component C/(component A+component B)) is set to 1.05 to 0.97 at the start of polymerization; and
(ii) the component C is further added to ensure that the weight ratio of the component C to the dihydroxy component (component C/(component A+component B)) during polymerization becomes 1.08 to 1.00.

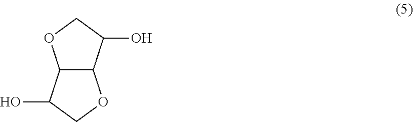

15. The production process according to claim 14, wherein diphenyl carbonate is used as the diester carbonate component (component C).

16. A molded article formed from the polycarbonate resin of claim 1.

17. The molded article according to claim 16 which is a film.

18. The molded article according to claim 16 which has a dimensional change rate of 1.5% or less at the time of the saturation water absorption of a molded article having a length of 100 mm, a width of 50 mm and a thickness of 4 mm.
